(19) United States
(12) Patent Application Publication
(10) Pub. No.: US 2026/0278951 A1
(43) Pub. Date: Sep. 17, 2026

(54) Calibration of Augmented Reality Systems

(71) Applicant: Procore Technologies, Inc., Carpinteria, CA (US)

(72) Inventors: David McCool, Carpinteria, CA (US); Christopher Myers, Council, ID (US); Ritu Parekh, San Jose, CA (US)

(21) Appl. No.: 19/323,864

(22) Filed: Sep. 9, 2025

Related U.S. Application Data
(60) Provisional application No. 63/773,425, filed on Mar. 17, 2025.

(51) Int. Cl. G06T 19/00; G06T 19/20

(52) U.S. Cl. CPC G06T 19/006; G06T 19/20; G06T 2219/2004; G06T 2219/2016

(57) ABSTRACT

A computing device is configured to (i) receive a command to calibrate a 3D model to a real-world environment, (ii) display image data of the real-world environment currently being captured by a camera of the computing device and an instruction to point the camera toward a ground surface, (iii) capture sensor data indicating the ground surface, (iv) display a visual representation of the 3D model and an instruction to select, within the 3D model, a floor that corresponds to the ground surface, (v) receive a selection of a floor, (vi) based on the selection, vertically align the selected floor with the sensor data indicating the ground surface, (vii) while displaying both the 3D model and image data, receive user input indicating commands to laterally translate the 3D model or rotate, about a z-axis of the 3D model, the visual representation of the 3D model with respect to the image data.

### CROSS-REFERENCE TO RELATED APPLICATIONS

This application claims priority under U.S.C. § 119(e) to U.S. Provisional Application No. 63/773,425 filed on Mar. 17, 2025 and titled “Calibration of Augmented Reality Systems,” the contents of which are incorporated by reference herein in their entirety.

### BACKGROUND

Augmented Reality (“AR”) is a technology that overlays computer-generated graphics (i.e., virtual content) on a view of a real-world environment to provide an enhanced view of the real-world environment. In this respect, virtual content is generally superimposed in such a way as to appear as a natural part of the real-world environment.

To superimpose virtual content on a view of the real-world environment, a computing device with AR capabilities (which may be referred to herein as an “AR-enabled device”), generally functions to present a view of the real-world environment that has overlaid virtual content, which may be generated by the AR-enabled device or received from another computing device. Many types of AR-enabled devices exist, such as a smartphone, tablet, laptop, and wearable devices (e.g., head-mounted displays), among other computing devices. Depending on the type of AR-enabled device being used to experience AR, an enhanced view that superimposes virtual content on a view of the real-world environment may be presented in various manners.

For example, in certain types of AR-enabled devices such as a head-mounted display, the view of the real-world environment may be what the user perceives through the lens of the head-mounted display, and the enhanced view may be presented on the head-mounted display with virtual content overlaid on the view of the real-world environment. As another example, the enhanced view may be presented on a display screen of an AR-enabled device, in which case the computing device may comprise a camera that captures the real-world environment in the form of image data that is presented via the display screen along with the overlaid virtual content.

### SUMMARY

Disclosed herein is a new software technology for improved AR calibration between a 3D model and a real-world environment that is flexible to meet user needs and can be utilized at any stage of construction.

In one aspect, the disclosed technology may take the form of a method that involves (i) receiving a first user input indicating a command to calibrate a 3D model to a real-world environment, (ii) based on the first user input, displaying (a) image data of the real-world environment currently being captured by the at least one camera and (b) an instruction to point the at least one camera of the computing device downward toward a ground surface within the real-world environment, (iii) capturing sensor data indicating the ground surface within the real-world environment, (iv) based on capturing the sensor data indicating the ground surface, displaying (a) a visual representation of the 3D model and (b) an instruction to select, within the visual representation of the 3D model, a floor that corresponds to the ground surface, (v) receiving a second user input indicating a selection of a floor within the 3D model, (vi) based on the second user input, vertically aligning the selected floor within the 3D model with the sensor data indicating the ground surface within the real-world environment, (vii) after vertically aligning the selected floor within the 3D model, and while displaying both the visual representation of the 3D model and image data of the real-world environment currently being captured by the at least one camera, receiving one or more third user inputs indicating one or more respective commands to (a) laterally translate the visual representation of the 3D model with respect to the image data or (b) rotate, about a z-axis of the 3D model, the visual representation of the 3D model with respect to the image data, and (viii) receiving a fourth user input indicating that the 3D model is calibrated to the real-world environment.

In some examples, the method may involve, based on the first user input, automatically transitioning from displaying the visual representation of the 3D model to displaying image data of the real-world environment currently being captured by the at least one camera, wherein the instruction is overlaid on the image data.

Further, in some examples, the method may involve, based on capturing the sensor data indicating the ground surface, automatically transition from displaying image data of the real-world environment currently being captured by the at least one camera to displaying a visual representation of the 3D model, wherein the instruction is overlaid on the visual representation of the 3D model.

Still further, in some examples, the method may involve, based on based on detecting the second user input, automatically transition from displaying the visual representation of the 3D model to displaying both a visual representation of the 3D model and image data of the real-world environment currently being captured by the at least one camera.

Still further, in some examples, the sensor data may include point cloud data captured by a LiDAR unit of the computing device.

Still further, in some examples, the method may involve displaying a selectable indication that, when selected, causes the vertical alignment of the 3D model with respect to the real-world environment to be adjusted by a predetermined distance.

Still further, in some examples, the method may involve, after receiving the fourth user input and while displaying both the visual representation of the 3D model and image data of the real-world environment currently being captured by the at least one camera, displaying a selectable indication that, when selected, adjusts the opacity of the visual representation of the 3D model and, based on receiving an input indicating a user selection of the selectable indication, increasing or decreasing the opacity of the visual representation of the 3D model.

Still further, in some examples, the method may involve, after receiving the fourth user input and while displaying both the visual representation of the 3D model and image data of the real-world environment currently being captured by the at least one camera, displaying a selectable indication that, when selected, hides one or more classes of objects within the 3D model and, based on receiving an input indicating user selection of the selectable indication, removing the one or more classes of objects from the visual representation of the 3D model.

In another aspect, the disclosed technology may take the form of a method that involves (i) capturing sensor data corresponding to a real-world environment, the sensor data comprising image data captured via the at least one camera, (ii) based on the captured sensor data, identify a point on an object in the real-world environment, (iii) display a visual representation of the identified point on the object, (iv) determine a first vector in a real space coordinate frame, the first vector extending between the identified point and a position of the at least one camera in the real world environment, (v) display (a) a visual representation of a 3D model from a viewing perspective that corresponds to a position of a virtual camera in the 3D model and (b) an instruction to select a corresponding point in the 3D model, (vi) receive an input indicating a selection of the corresponding point in the 3D model, (vii) determine a second vector in a model space coordinate frame, the second vector extending between the corresponding point and a position of the virtual camera in the 3D model, (vii) determine a translation and a rotation of the viewing perspective of the 3D model such that the second vector is aligned with the first vector, and (viii) calibrate the 3D model to the real-world environment by (a) translating the viewing perspective of the 3D model by the determined translation and (b) rotating the viewing perspective of the 3D model by the determined rotation.

In another aspect, the disclosed technology may take the form of a computing device comprising at least one processor, at least one non-transitory computer-readable medium, and program instructions stored on the at least one non-transitory computer-readable medium that, when executed by the at least one processor, cause the computing device to carry out the functions of any of the aforementioned methods.

In yet another aspect, the disclosed technology may take the form of a non-transitory computer-readable medium comprising program instructions stored thereon that, when executed by the at least one processor, cause a computing device to carry out the functions of any of the aforementioned methods.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### BRIEF DESCRIPTION OF THE DRAWINGS

FIG. 1 depicts a GUI view illustrating an example of a conventional approach to AR calibration.

FIG. 2 depicts a GUI view illustrating a 3D model displayed from a given perspective, along with navigational controls, in accordance with the software technology disclosed herein.

FIG. 3 depicts a GUI view illustrating image data that is being captured via one or more cameras of an AR-enabled device, in accordance with the software technology disclosed herein.

FIG. 4 depicts a GUI view illustrating image data captured by the one or more cameras of the AR-enabled device, in accordance with the software technology disclosed herein.

FIG. 5 depicts a GUI view that displays an instruction, overlaid on a representation of a 3D model, in accordance with the software technology disclosed herein.

FIG. 6 depicts a GUI view illustrating an interface adjusting the orientation of a 3D model with respect to captured image data, in accordance with the software technology disclosed herein.

FIG. 7 depicts a GUI view illustrating an updated interface with respect to FIG. 6, in which the 3D model is aligned more closely with the real-world environment, in accordance with the software technology disclosed herein.

FIG. 8 depicts a GUI view illustrating an updated interface with respect to FIG. 7, in which a user has toggled a viewing mode, in accordance with the software technology disclosed herein.

FIG. 9 depicts a GUI view illustrating another updated interface with respect to FIGS. 7 and 8, in which a user has toggled a viewing mode, in accordance with the software technology disclosed herein.

FIG. 10 depicts a GUI view illustrating an updated interface with respect to FIG. 9, in which a user has selected an opacity of the 3D model of 60%, in accordance with the software technology disclosed herein.

FIG. 11 depicts another GUI view illustrating an updated interface with respect to FIG. 10, in which a user has selected an opacity of the 3D model of 2%, in accordance with the software technology disclosed herein.

FIG. 12 depicts yet another a GUI view illustrating an updated interface with respect to FIG. 11, in which the user has selected an opacity of the 3D model of 100%, in accordance with the software technology disclosed herein.

FIG. 13 depicts a GUI view illustrating another view of image data representing a real-world environment and an associated 3D model, in accordance with the software technology disclosed herein.

FIG. 14 depicts a GUI view illustrating an updated interface with respect to FIG. 13, in which a user has toggled a viewing mode, in accordance with the software technology disclosed herein.

FIG. 15 depicts a GUI view illustrating an updated interface with respect to FIG. 14, in which a user has toggled a viewing mode, in accordance with the software technology disclosed herein.

FIG. 16 depicts a GUI view illustrating an updated interface with respect to FIG. 15, wherein an object tree is overlaid on the GUI view, in accordance with the software technology disclosed herein.

FIG. 17 depicts a GUI view in which various architectural objects of the 3D model are hidden and the opacity of the 3D model is decreased to 0%, in accordance with the software technology disclosed herein.

FIG. 18 depicts an updated GUI view with respect to FIG. 17, in which a user has increased the opacity of the 3D model to 31%, in accordance with the software technology disclosed herein.

FIG. 19 depicts an updated GUI view with respect to FIG. 18, in which a user has adjusted the orientation of the AR-enabled device to point in a more upward direction, in accordance with the software technology disclosed herein.

FIG. 20 depicts another updated GUI view with respect to FIG. 19, in which a user has further adjusted the upward orientation of the AR-enabled device, in accordance with the software technology disclosed herein.

FIG. 21 depicts a GUI view of image data of a construction project in which steel beams and a steel floor deck have been installed, but concrete floor slabs have not.

FIG. 22 depicts a GUI view that may be presented by an AR-enabled device during an AR-calibration process, in accordance with the software technology disclosed herein.

FIG. 23 depicts another GUI view that may be presented by the AR-enabled device during the AR-calibration process shown in FIG. 22, in accordance with the software technology disclosed herein.

FIG. 24 depicts a flowchart that includes one possible implementation of software functionality that may be carried out by the computing systems disclosed herein.

FIG. 25 depicts a flowchart that includes one possible implementation of software functionality that may be carried out by the computing systems disclosed herein.

FIG. 26 depicts an example network configuration in which the embodiments of the disclosed software technology may be implemented.

FIG. 27 depicts a simplified block diagram that illustrates some structural components that may be included in an example computing platform that may be configured to carry out one or more of the functions of the present disclosure.

FIG. 28 depicts a simplified block diagram that illustrates some structural components that may be included in an example AR-enabled client device that may be configured to carry out one or more of the functions of the present disclosure.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

AR can provide value in various fields in which the use of AR is currently limited. For instance, AR can enhance user experience in fields including construction, industrial design, entertainment (e.g., gaming), and/or home decoration, as some non-limiting examples.

Generally speaking, in the field of construction, a construction project may involve the creation, review, and sometimes revision, of plans (e.g., drawings) of the construction project. These plans may comprise visual representations of the construction project that visually communicate information about the construction project, such as how to assemble or construct the project. Such visual representations tend to take one of at least two different forms.

One form may be a two-dimensional (“2D”) model, such as an architectural drawing, engineering drawing, shop drawing (or the like), in which 2D line segments of the 2D model represent certain physical elements of the construction project (e.g., walls, pipes, ducts, furniture, etc.). In this respect, a 2D model may be embodied either in paper form or in a computerized form, such as an image file (e.g., a PDF file, JPEG file, etc.).

To advance over 2D models, computerized, three-dimensional (“3D”) technology was developed as another form in which information about a construction project can be visually communicated. In this respect, a 3D model of the construction project is typically embodied in a computerized form, such as in a Building Information Model (“BIM”) file, with 3D meshes visually representing the physical elements of the construction project (e.g., walls, ducts, ceilings, pipes, conduits, furniture, etc.). The BIM file can include a vast amount of data describing the individual physical elements of the construction project and the relationships between these individual physical elements, including for instance, the relative position, size, and/or shape of each element, and an indication of where each element will reside in relation to the other elements in the construction project. In this regard, each physical element represented within a 3D model is typically drawn to match the real-life dimensions of the physical element, such that the 3D model is a 1:1 representation of the physical element in the real world.

Correspondingly, specialized software has been developed that is capable of accessing a BIM file and rendering a 3D model of the construction project from one or more perspectives. One type of specialized software tool that currently exists is known as a “BIM viewer.” Generally speaking, a BIM viewer is a software tool that accesses the information contained within a BIM file (or a combination of BIM files) for a particular construction project and then, based on that file (or those files), is configured to cause a client station (e.g., a desktop computer, a laptop computer, a tablet, a smart phone, a wearable device, or the like) to render a 3D model of the computerized representation of the construction project. The BIM viewer software tool may also facilitate navigation of the rendered 3D model of the construction project. For example, the BIM viewer software tool may facilitate navigation of the 3D model by adjusting the perspective from which the 3D model is viewed. In this regard, the viewing perspective may be conceptualized by referring to a virtual camera within the 3D model, from which the 3D model is being viewed. The virtual camera has both a position (e.g., expressed in x, y, and z coordinates) and an orientation, which corresponds to the direction the virtual camera is pointing. To navigate the 3D model, a user may adjust the position of the virtual camera along either or both of the lateral axes of the 3D model (e.g., x- and y-axes) or along the vertical axis (e.g., the z-axis), which moves the viewing position of the virtual camera. Additionally, the user may navigate the 3D model by adjusting the orientation of the virtual camera, which changes the direction the virtual camera is pointing without changing its position (e.g., by rotating the viewing perspective laterally or vertically).

In practice, to facilitate these types of navigation, the BIM viewer software tool may generate a graphical user interface (“GUI”) that presents the 3D model of the construction project as well as one or more navigational controls overlaid on the 3D model. The BIM viewer tool may also be configured to receive user input at the navigational controls (e.g., a touch, or a touch combined with a drag) and, based on a respective user input, change the viewing perspective from which the BIM viewer tool renders the 3D model. These navigational controls may take various forms, many of which are discussed in U.S. Pat. No. 11,222,475, which is incorporated by reference herein in its entirety.

In addition to viewing and navigating 3D models in isolation, the types of BIM viewer software tools discussed above may also facilitate AR experiences, in which a 3D model of a construction project is overlaid on view of the real-world environment in which the real-world physical elements of the construction project that are represented in the 3D model have been, or will be, constructed. In general, this is accomplished via an AR-enabled device (e.g., a laptop, tablet, smartphone, wearable device, etc.) that includes a BIM viewer software tool for viewing the 3D model as well as one or more cameras for capturing image data in the real-world environment. By aligning the position and orientation of the virtual camera within the 3D model (i.e., the viewing perspective from which the 3D model is displayed) with the real-world position and orientation of the AR-enabled device (i.e., the camera of the AR-enabled device), the digital representations of the physical elements in the 3D model may be overlaid on the image data captured by the camera of the AR-enabled device, such that the physical elements from the 3D model are aligned with their corresponding locations within the real-world environment. Further, once the viewing perspective of the virtual camera within the 3D model has been aligned with the real-world viewing perspective AR-enabled device, the viewing perspective of the virtual camera may be “locked” to the viewing perspective of the AR-enabled device. For example, as the AR-enabled device is moved in the real-world, one or more motion sensors of the AR-enabled device (e.g., gyroscopes, accelerometers, magnetometers, inertial measurement units (IMUs), cameras, etc.) may detect this movement. The AR-enabled device may then convert this detected movement into commands to update the viewing perspective of the 3D model in a corresponding way. Accordingly, as a user moves the AR-enabled device through the real-world environment and the image data captured and displayed by the AR-enabled device's camera changes, the viewing perspective of the overlaid 3D model changes in a corresponding way, maintaining the alignment of the 3D model with the real-world environment.

However, the alignment of the 3D model with the real-world environment, a process that may also be referred to herein as AR calibration or simply calibration, can be challenging to accomplish in practice. In particular, it can be difficult to visually align the coordinate frame of the 3D model—which may also be referred to herein as model space—with the coordinate frame of the real-world environment—which may also be referred to herein as real space—based on a displayed representation of the 3D model in combination with image data from an AR-enabled device's camera. One reason for this difficulty is that the coordinate frames have multiple degrees of freedom, along multiple axes, that may need to be adjusted to align the two coordinate frames. For instance, a user may need to adjust the viewing perspective of the virtual camera within the 3D model by inputting one or more navigational controls to translate and/or rotate the displayed view of the 3D model and multiple directions. Further, aligning the two coordinate frames in three dimensions may require visual references along multiple dimensions, some of which may be difficult to perceive from a single location. As a result, many current calibration techniques can be disorienting for users and time consuming to complete, requiring numerous iterations repositioning the AR-enabled device and/or the displayed 3D model to refine the alignment between the two coordinate spaces.

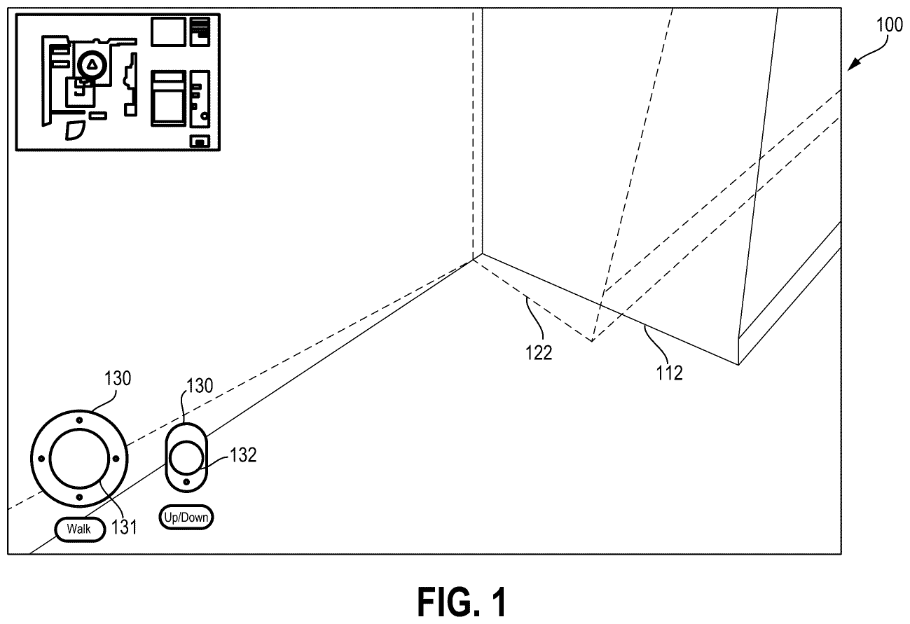

One representative example of a current calibration approach is shown in FIG. 1, which depicts a GUI view 100 that may be displayed by an AR-enabled device during an AR calibration process on a given construction project. As shown in FIG. 1, the GUI view 100 includes a representation of the real-world environment currently being captured by a camera of the AR-enabled device. The GUI view also includes a representation of the 3D model, from a viewing perspective that corresponds to approximately the same position and orientation in model space as the user's position and orientation in real space.

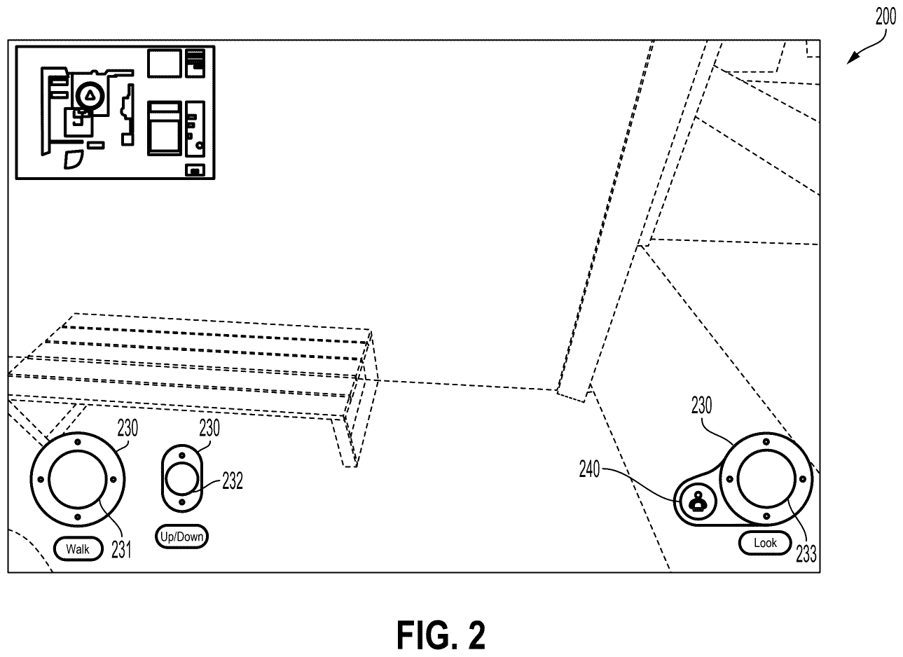

In the GUI view 100 of FIG. 1, the representation of the real-world environment displayed via image data is illustrated and called out using solid lines, whereas the representation of the 3D model is illustrated and called out using dashed lines. FIGS. 2-23 follow a similar convention, wherein representations of real-world environments are depicted using solid lines and representations of 3D models are depicted using dashed lines. In FIG. 1 and other subsequent figures, interface components in GUI views (that may be overlaid on one or both of representations of real-world environments and representations of 3D models) are illustrated in bolded, solid lines.

While the GUI view 100 shows representations of both the real-world environment and the 3D model, it is apparent that the two coordinate frames are not fully aligned. In addition to a rotation offset, the length of the wall section 112 (shown via the AR-enabled device's camera) is longer than the length of the corresponding wall section 122 in the 3D model, indicating a mismatch in scale.

As noted above, the user can attempt to resolve the misalignment by adjusting the displayed 3D model using one or more navigational controls 130. As shown in FIG. 1, the GUI view 100 includes a first joystick 131 labeled “Walk” that the user can operate (e.g., via touch inputs) to translate the viewing perspective of the virtual camera laterally either left/right or forward/backward (i.e., along the x- or y-axes within model space). The GUI view 100 also includes a second joystick 132 labeled “Up/Down” that the user can operate to translate the viewing perspective of the virtual camera vertically up/down (i.e., along the z-axis within model space). In the example GUI view 100 shown in FIG. 1, a user may also provide a touch and drag input to the AR-enabled device to rotate the viewing perspective of the virtual camera either up/down or left/right, changing its orientation without changing its position. In some other implementations, a third joystick labeled “Look” (not shown) may be provided, which a user may operate to rotate the viewing perspective of the virtual camera, as an alternative to or in addition to using touch and drag inputs.

In the example GUI view 100 shown in FIG. 1, the length of the wall section 122 in the 3D model appears smaller in scale than the wall section 112 in the real-world environment because the viewing perspective of the virtual camera in the 3D model is located further away from the wall in the 3D model than the AR-enabled device is located in relation to the wall in the real-world environment. Therefore, as part of aligning the two coordinate frames, the user must translate the viewing perspective of the virtual camera down using the second joystick.

However, adjusting the 3D model vertically along the z-axis can be challenging to do accurately. In particular, it can be difficult to tell when the floor in the 3D model is visually aligned with the floor in the real-world environment, based on the user's vantage point. Moreover, it will be appreciated that calibration using the techniques discussed above may involve a lengthy series of refinements, including adjustments of the 3D model, movements of the AR-enabled device, readjustments of the 3D model, and so on.

Some AR technologies have attempted to improve upon this approach to calibration. For example, some AR technologies allow a user to use an AR-enabled device to detect, and then select, a series of intersecting surfaces within the real-world environment, such as wall surfaces, floor surfaces, and/or ceiling surfaces. Then, the user selects the same surfaces in the 3D model that correspond to the surfaces they selected within the real-world environment. Based on the selections, the AR-enabled device may align the model space coordinate frame of the 3D model with the real-world coordinate frame of the AR-enabled device's camera. However, these types of approaches are limited in their application by the construction progress on a given construction project. In particular, these types of approaches are difficult or impossible to implement when the walls and/or other surfaces have not been installed yet, providing no reference surfaces in the real-world environment on which to base the calibration.

To improve upon these and other shortcomings associated with existing technologies for AR calibration, disclosed herein is software technology that provides for improved AR calibration that is flexible to meet user needs and can be utilized at any stage of construction. At a high level, the disclosed software technology involves utilizing one or more sensors of an AR-enabled device to detect a ground surface in the real-world environment, and then receiving a user selection, within a 3D model displayed via BIM viewer software running on the AR-enabled device, of a floor within the 3D model that corresponds to the detected ground surface, thereby calibrating the vertical axis of the 3D model with the real-world environment. A user may then utilize the AR-enabled device to align the 3D model with the real-world environment along the 3D model's other axes, requiring relatively few reference objects within the real-world environment while simultaneously providing several adjustable viewing modes for the 3D model to aid the user during the calibration process.

A series of GUI views depicting an example of the AR calibration approach enabled by the new software technology disclosed herein can be seen starting with FIG. 2. As shown in FIG. 2, a user may utilize a BIM-viewer on an AR-enabled device, such as a smartphone, tablet, or the like, to view a 3D model that corresponds to the real-world environment in which the user is located. For purposes of the following example, it is assumed that the user has navigated within the 3D model to the user's approximate corresponding location within the real-world environment.

Accordingly, the GUI view shown in FIG. 2 depicts a 3D model displayed from a given perspective, along with navigational controls 230 that the user may utilize to navigate within the 3D model and thereby adjust the viewing perspective of the 3D model. For example, the navigational controls may comprise one or more of a first joystick 231 (e.g., a “Walk” joystick that the user can operate to translate the viewing perspective of the virtual camera laterally either left/right or forward/backward), a second joystick 232 (e.g., an “Up/Down” joystick that the user can operate to translate the viewing perspective of the virtual camera vertically up/down), and/or a third joystick 233 (e.g., a “Look” joystick, which a user may operate to rotate the viewing perspective of the virtual camera). As another possibility, the navigational controls may be implemented without one or more of the joysticks (or similar dedicated control elements) for specific adjustments. For instance, in place of the third joystick 233, a user might provide directional touchscreen inputs anywhere within the GUI view shown in FIG. 2 to rotate the viewing perspective of the virtual camera vertically or horizontally. The navigational controls 230 may take various other forms, as well.

The GUI view of the BIM viewer software shown in FIG. 2 also includes a selectable option to enter an AR mode. In FIG. 2, the selectable option takes the form of an AR-mode button 240 incorporated into the third joystick 233. However, other examples are also possible, such as an icon within a toolbar (not pictured), among other possibilities. A user selection of the AR mode option may indicate a command to calibrate the 3D model with the real-world environment. Based on the user selection of the AR mode option, the AR-enabled device may transition from displaying the 3D model via the BIM viewer software to displaying image data that is currently being captured by one or more cameras of the AR-enabled device. In some implementations, this may additionally involve automatically activating the one or more cameras to begin capturing image data.

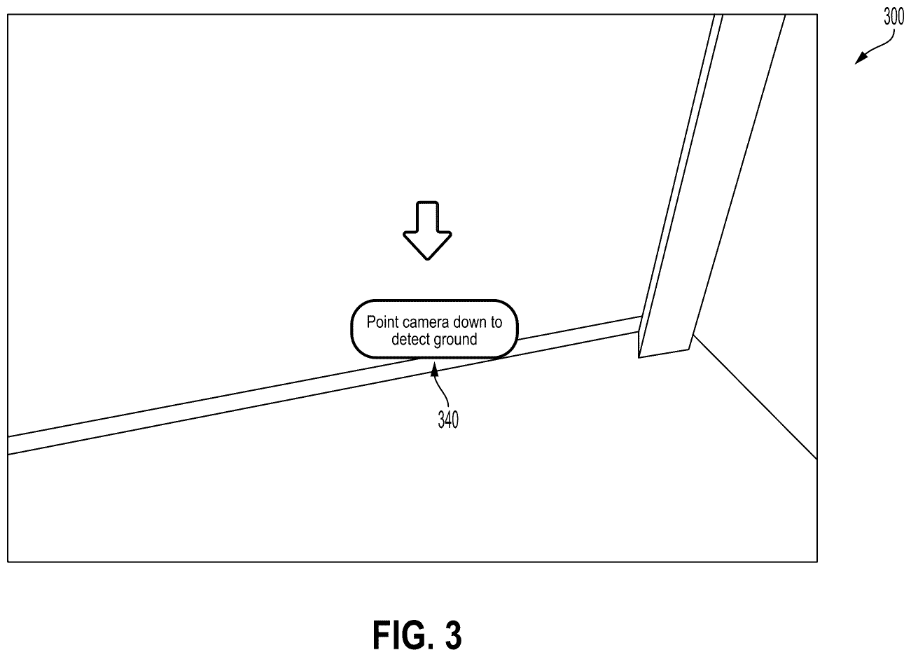

FIG. 3 depicts a GUI view 300 after this transition has occurred, wherein the AR-enabled device now displays image data that is being captured in the real-world environment. In addition, the AR-enabled device displays an instruction 340, overlaid on the image data, that directs the user to point the camera of the AR-enabled device down in order to detect the ground. For purposes of the current example, it will be assumed that the user is standing on an already-constructed floor of a building that is represented by a physical element within the 3D model. However, this might not always be the case, as will be addressed in further detail below.

When the user points the camera of the AR-enabled device down, the AR-enabled device may capture sensor data that indicates the ground surface within the real-world environment. The sensor data may take various forms, including 3D point cloud data captured by one or more LiDAR sensors of the AR-enabled device, image data captured by one or more cameras (e.g., stereo cameras) of the AR-enabled device, among other possibilities including combinations of the above.

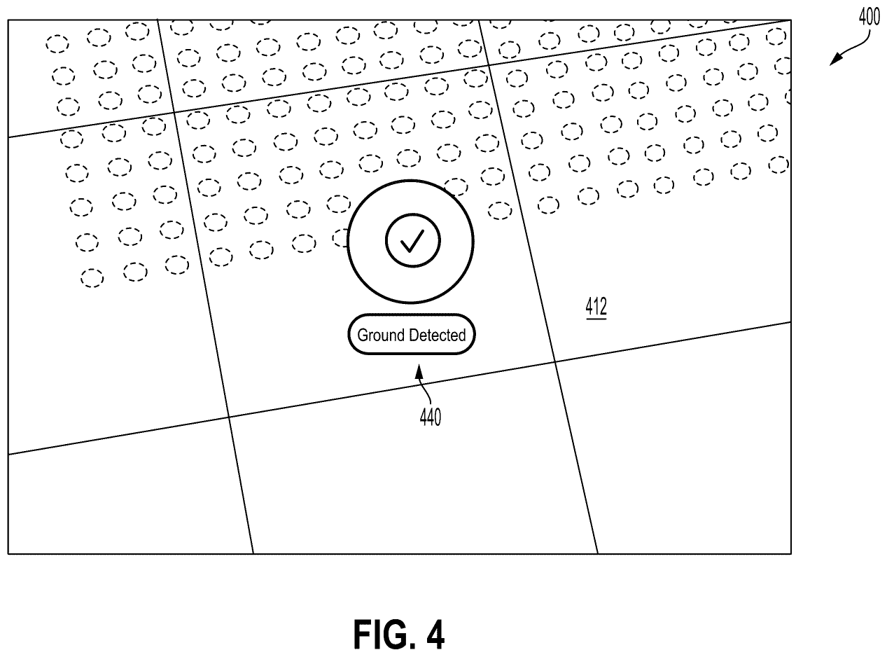

FIG. 4 depicts a GUI view 400 showing image data captured by the one or more cameras of the AR-enabled device after the user has pointed it toward a ground surface 412. The GUI view 400 further includes an overlaid notification 440 indicating the ground surface 412 has been successfully detected by the AR-enabled device. Based on detecting the ground surface 412, the AR-enabled device may determine a distance to the ground surface 412 (e.g., a distance from the one or more cameras to the ground surface 412) and thereby establish a relative z-axis elevation of the ground surface 412 with respect to the AR-enabled device in real space, at the time of detection. Thereafter, as the user moves the AR-enabled device in the real-world environment, the AR-enabled device may detect this movement via one or more motion sensors (e.g., gyroscopes, accelerometers, magnetometers, inertial measurement units (IMUs), cameras, etc.) and update the relative z-axis elevation of the ground surface 412 accordingly.

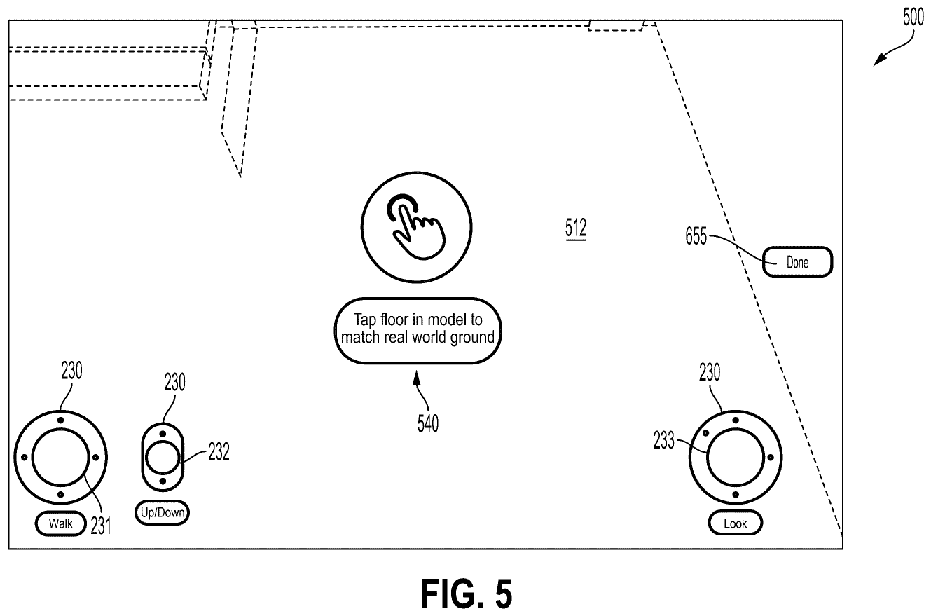

After the AR-enabled device has detected the ground surface 412 as discussed above, the AR-enabled device may transition from displaying the currently-captured image data back to displaying the 3D model via the BIM viewer software. A GUI view 500 reflecting this transition back can be seen in FIG. 5. In addition, and as also shown in FIG. 5, the AR-enabled device displays an instruction 540, overlaid on the representation of the 3D model, that directs the user to select a floor 512 within the 3D model that corresponds to the ground surface 412 detected in the previous step.

When the user selects the floor 512 within the 3D model, the AR-enabled device may align the z-axis elevation of the selected floor 512 within the 3D model with the z-axis elevation of the ground surface 412 with respect to the AR-enabled device. This, in turn, may serve to establish the same vertical elevation of the virtual camera within the 3D model, with respect to the selected floor 512, as the AR-enabled device has with respect to the detected ground surface 412. Accordingly, the AR-enabled device may establish the vertical calibration of the 3D model with the real-world environment, as displayed by the AR-enabled device.

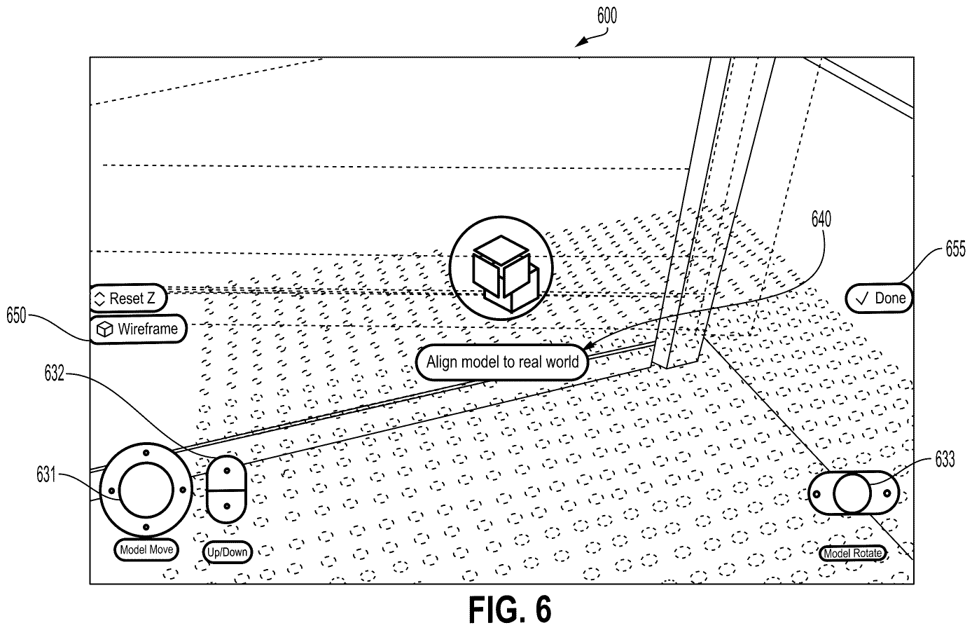

In addition, based on the user selection of the floor 512 within the 3D model, the AR-enabled device may again transition the GUI view 500 to display both the image data from the one or more cameras of the AR-enabled device along with the representation of the 3D model, which are now aligned with each other in the vertical (i.e., z-axis) direction. This can be seen in the updated GUI view 600 of FIG. 6. In addition, the AR-enabled device displays an overlaid instruction 640 that directs the user to align the 3D model to the real-world environment. In this regard, although some alignment is still needed, the viewing perspective of the 3D model is now locked with respect to the motion of the AR-enabled device, such that any movements of the AR-enabled device adjusts both the displayed image data of the real-world environment captured by the one or more cameras as well as the displayed view of the 3D model. Further, because the vertical elevation between the two coordinate frames has already been calibrated, the remaining alignment to be performed by the user is substantially simplified by removing the need for translations and rotations of the 3D model in the vertical direction. For example, the AR-enabled device may display a first joystick 631, labeled “Model Move” in the GUI view 600 of FIG. 6, that allows the user to translate the model left/right or forward/backward with respect to the image data, as well as a second joystick 633, labeled “Model Rotate” in the GUI view 600 of FIG. 6, that allows the user to rotate the model left/right (i.e., yaw rotations about the z-axis) with respect to the image data.

An additional alignment control element 632 labeled “Up/Down” is also displayed that allows for incremental adjustments to the established vertical calibration, which may be needed in some scenarios. These scenarios will be discussed in further detail below.

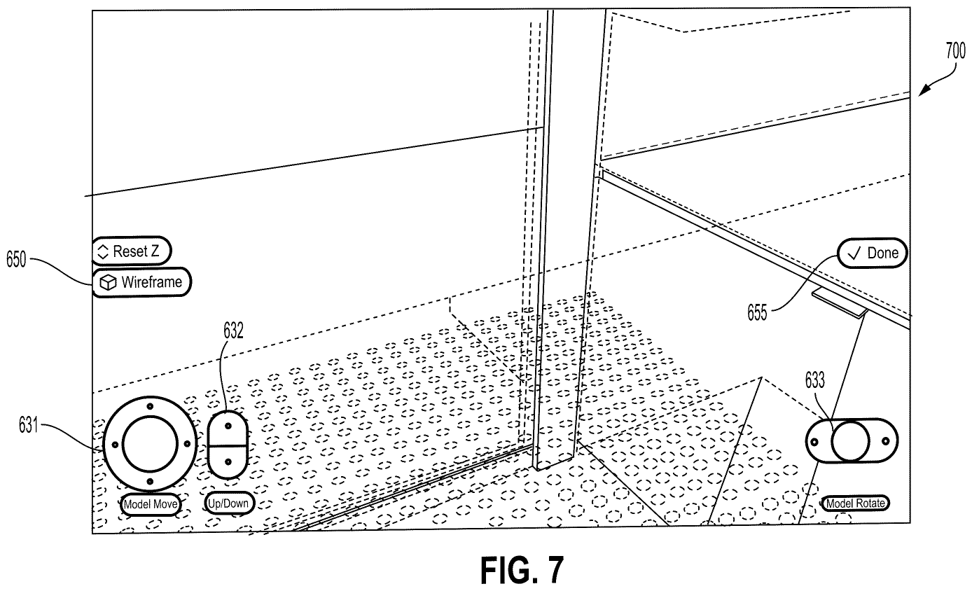

The AR-enabled device may also include other features to facilitate alignment at this stage in the calibration process. For example, the GUI view may include a selectable indication 650 that allows the user to toggle between different rendering modes for the 3D model, which may be helpful in some scenarios. Various other implementations of the selectable indication 650 are also possible. As shown in FIG. 6, the selectable indication 650 is set to a “Wireframe” rendering mode. In this mode, only the edges of the physical elements represented within the 3D model are outlined, which allows a user to look “through” representations of physical objects that would otherwise obscure other representations of objects behind them. This rendering mode can also be seen in FIG. 7, which depicts an updated GUI view 700 in which the user has aligned the 3D model more closely with the real-world environment.

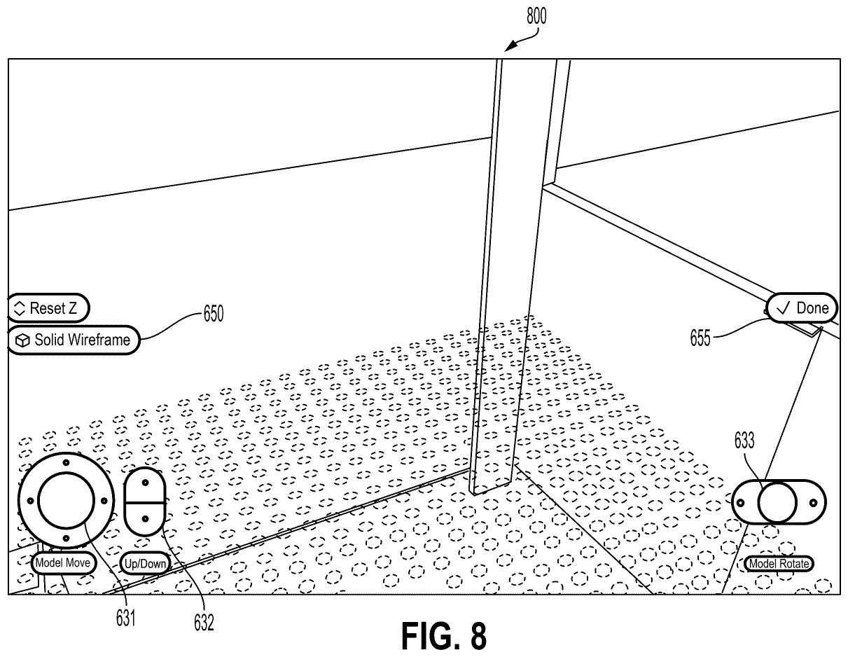

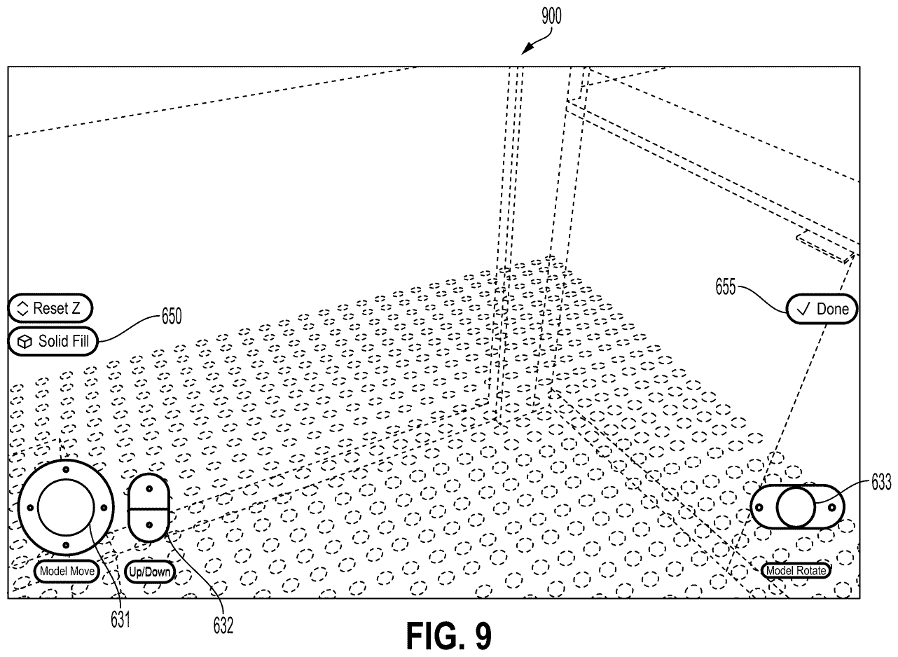

A second rendering mode is depicted in FIG. 8, which displays an updated GUI view 800 with respect to the GUI view 700 of FIG. 7. In FIG. 8, the user has toggled the selectable indication 650 such that the viewing mode is now set to “Solid Wireframe” in which the edges of physical objects are outlined but the objects are not transparent, which limits the wireframe view to the objects that the user can see. A third rendering mode is depicted in FIG. 9, which displays an updated GUI view 900 with respect to the GUI views 700, 800 of FIGS. 7 and 8. In FIG. 9, the user has toggled the selectable indication 650 such that the viewing mode is now set to “Solid Fill” in which the 3D model is depicted without alteration, as if the model were being viewed in isolation. Each of these rendering modes may be useful in different scenarios and the user can easily toggle between them.

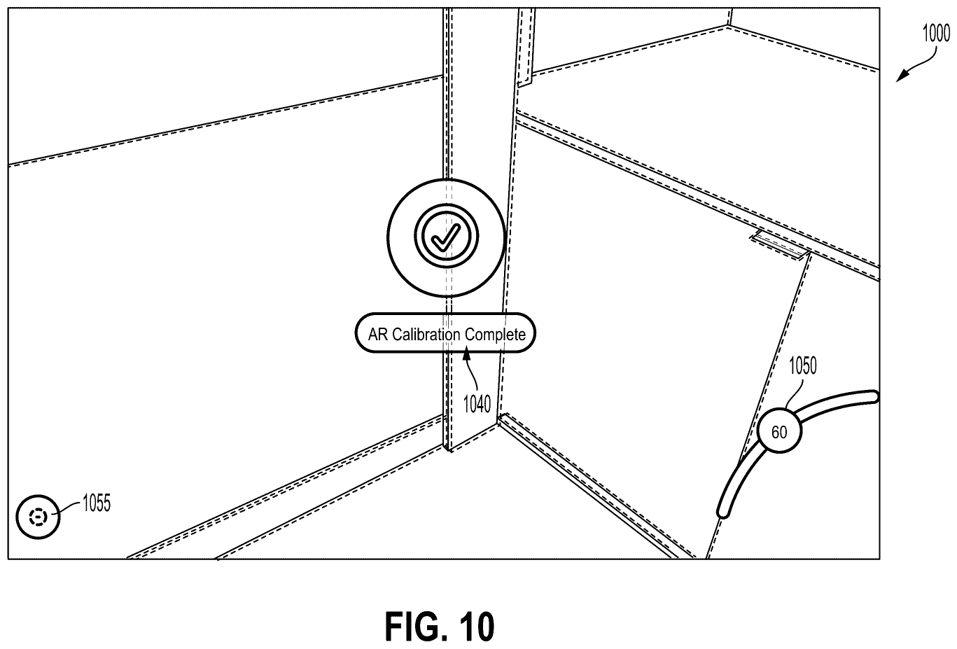

Once the user has aligned the 3D model with the real-world environment, the user may select an option 655 indicating that the user is done, and the calibration is complete. In response, the AR-enabled device may display an overlaid indication 1040 that the AR calibration is complete, as shown in a GUI view 1000 of FIG. 10.

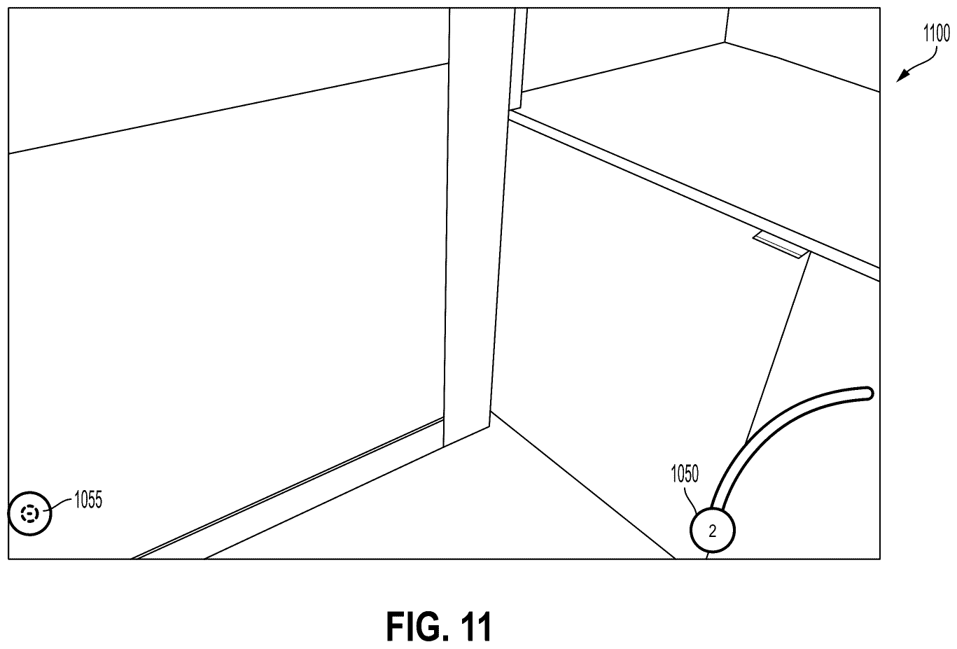

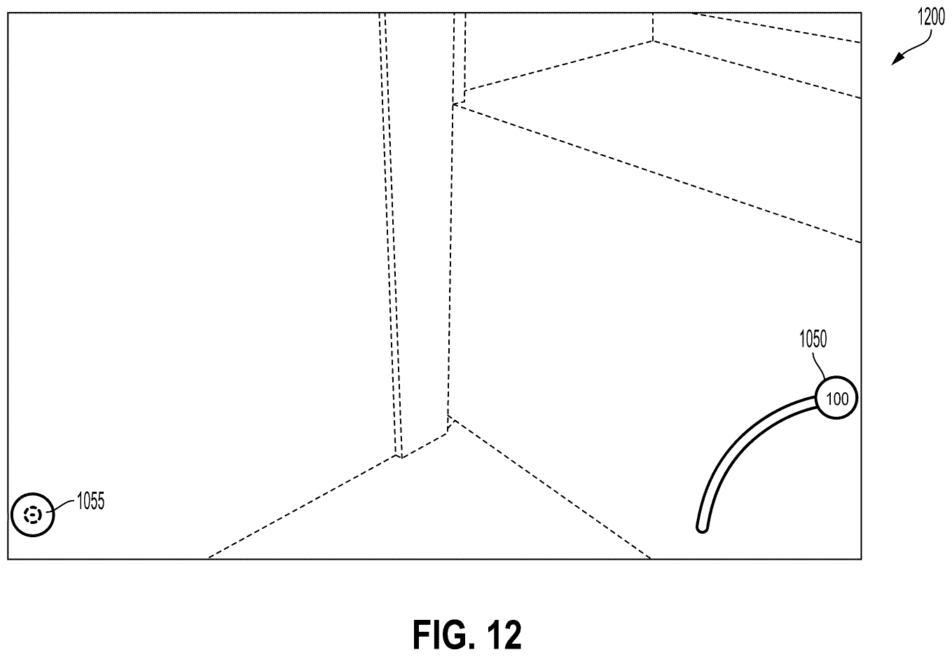

As may be appreciated with reference to FIGS. 6-9, the 3D model may be displayed in a semi-transparent state during the alignment stage, allowing features of both the 3D model and the real-world environment to be seen simultaneously. Once the calibration is completed, the AR-enabled device may display a selectable indication that allows the user to adjust the opacity of the 3D model. An example of this type of selectable indication is shown in FIG. 10 and takes the form of a slider 1050. For instance, in FIG. 10, the 3D model has an opacity value of 60% such that aspects of both the 3D model and the real-world environment represented by the image data captured by the AR-enabled device are visible. In an updated GUI view 1100 illustrated in FIG. 11, the user has adjusted the slider 1050 to set the opacity value of the 3D model to 2%, such that only the real-world environment represented by the image data is visible. Conversely, in another updated GUI view 1200 illustrated in FIG. 12, the user has adjusted the slider 1050 to set the opacity value of the 3D model to 100%, such that only the 3D model is visible.

In addition, FIGS. 10-12 each display a selectable AR-menu button 1055 that may provide a user with further options for customizing the AR view provided by the AR-enabled device.

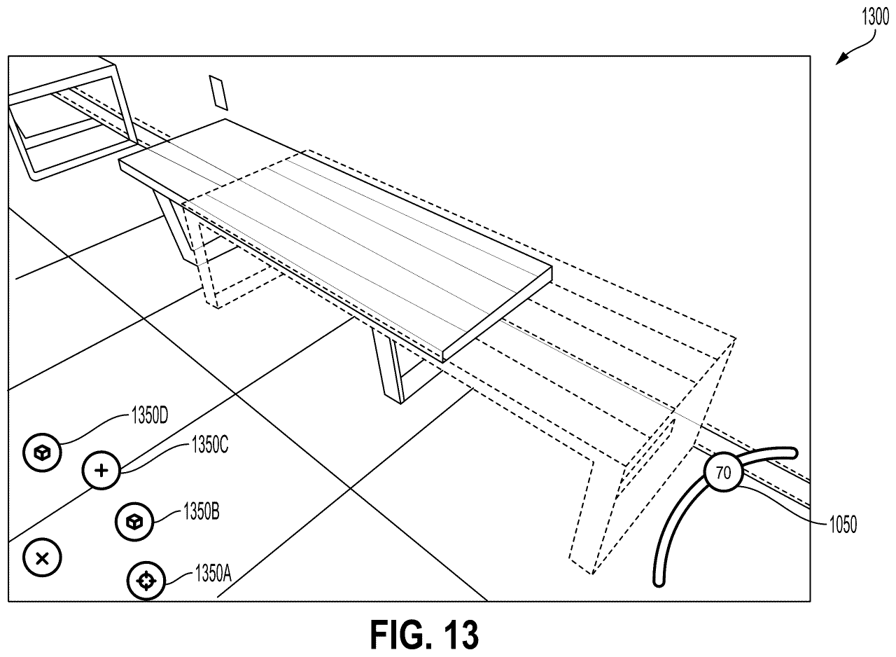

Turning to FIG. 13, a GUI view 1300 is depicted in which the user has moved the AR-enabled device to view a different area of the room in which the user is standing. Further the user has selected the AR menu button 1055 to reveal four selectable menu options 1350. A first selectable option 1350A may be selected to reinitiate the calibration process, beginning with the detection of a ground surface (e.g., comparable to the detection of the ground surface 310 as shown in FIG. 3). This option may be useful if the user determines that the calibration between the 3D model and the real-world environment has started to drift.

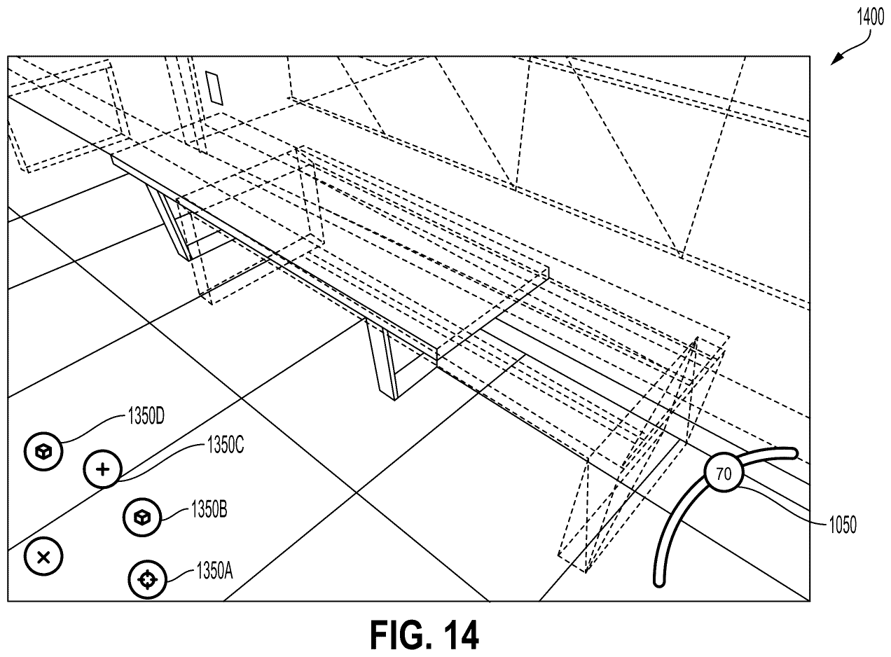

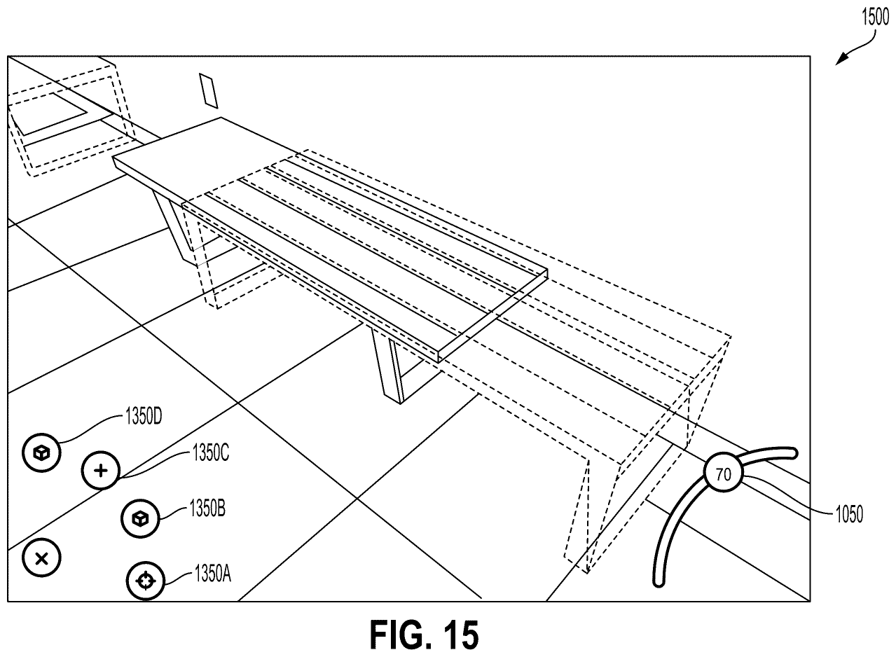

A second selectable option 1350B may allow the user to toggle the rendering mode of the 3D model, similar to the rendering mode toggle discussed above during the alignment stage. For example, FIG. 13 depicts the GUI view 1300 in which the rendering mode of the 3D model is set to “Solid Fill.” Alternatively, in a GUI view 1400 of FIG. 14, the user has toggled the rendering mode to “Wireframe” and, further still, in a GUI view 1500 of FIG. 15, the user has toggled the rendering mode to “Solid Wireframe.”

The third selectable menu option 1350C shown in FIGS. 13-15 may be selected to open a dialog box for creating a coordination issue. A coordination issue may take various forms, including observations of a potential installation conflict, a potential safety issue, and the like. Once created, the coordination issue may be synced with other tools within an overall construction management software application and may be linked with other data objects, such as RFIs and change orders. For example, when the user selects the option 1350C to create a coordination issue, the AR-enabled device may generate an image based on the currently displayed GUI view (e.g., the GUI view 1500) and attach the image to the coordination issue. In this regard, the user may select a desired rendering mode and set a desired opacity for the 3D model before creating the coordination issue, providing the user with useful flexibility in how the image attached to the coordination issue is displayed.

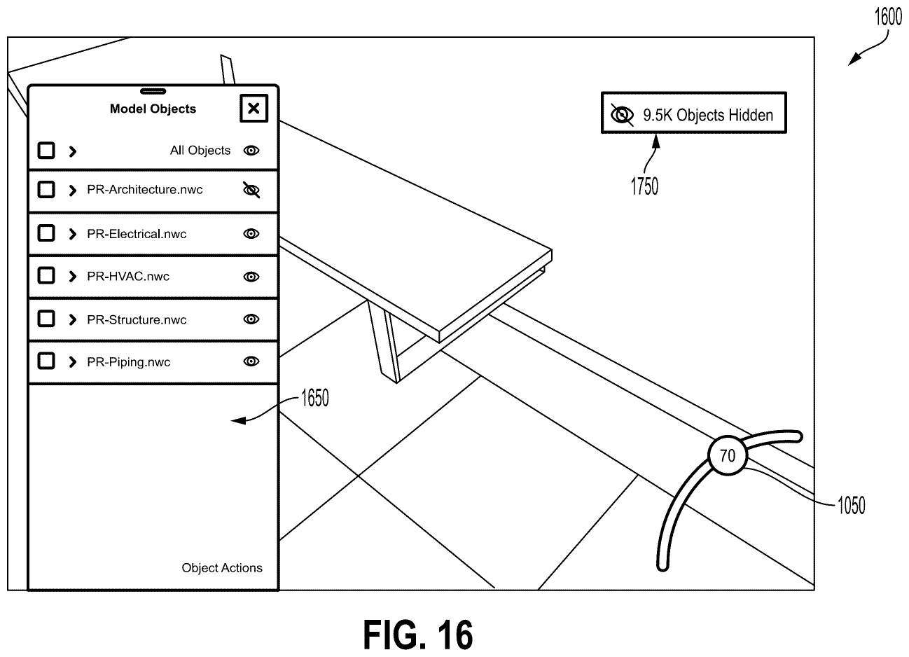

A fourth selectable option 1350D may be selected to open an object tree for the 3D model, which may be used to selectively hide objects within the 3D model so that they are not displayed in the AR view presented by the AR-enabled device. An example view of an object tree 1650 for the 3D model is shown in FIG. 16, which depicts a GUI view 1600 that may be displayed after the user selects the fourth selectable menu option 1350D. In FIG. 16, the object tree 1650 includes several top-level categories (e.g., classes) of objects that are included within the 3D model, such as Architectural objects (e.g., walls, doors, furniture, etc.) Electrical objects (e.g., electrical conduit, junction boxes, etc.), HVAC objects (e.g., heating and ventilation ductwork, etc.), Structure objects (e.g., load-bearing columns and beams, etc.) and Piping objects (e.g., pipes, plumbing fixtures, etc.). The user may select one or more of these categories of objects to expand the category and display a listing of sub-categories, which may include their own sub-categories, and so on. The various objects within a given 3D model may be categorized and sub-divided into other categories as well as those shown in FIG. 16.

In addition, at each level of the object tree 1650, the GUI view 1600 presented by the AR-enabled device may display a selectable option to hide all objects at that level (and at all included sub-levels). In the example shown in FIG. 16, the user has selected the option to hide all Architectural objects within the 3D model.

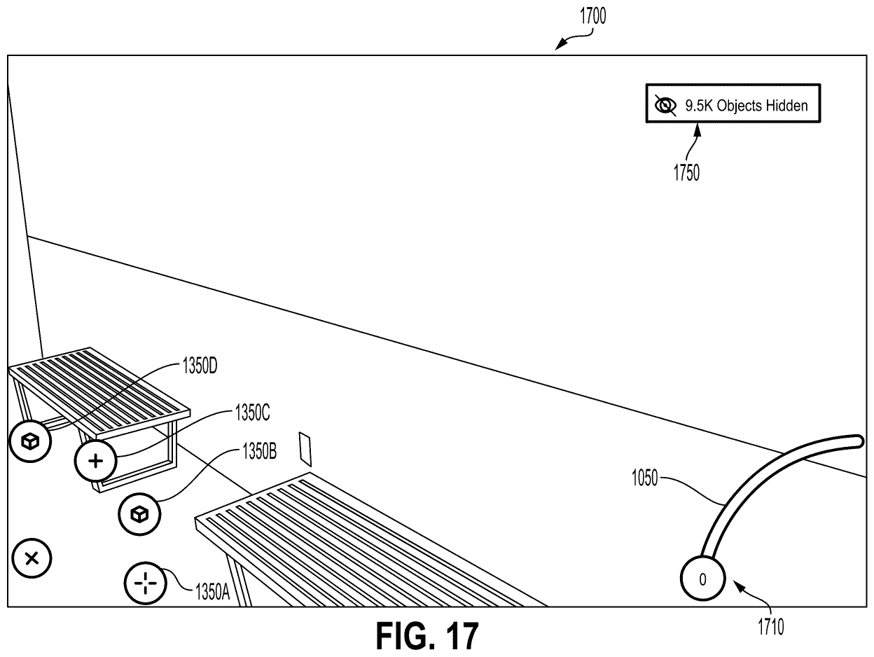

Turning to FIG. 17, a GUI view 1700 is depicted in which the architectural objects of the 3D model are hidden, as indicated by the notification 1750 in the upper right corner of the GUI view 1700. Further, the user has decreased the opacity of the 3D model such that only image data captured by the one or more cameras of the AR-enabled device is visible.

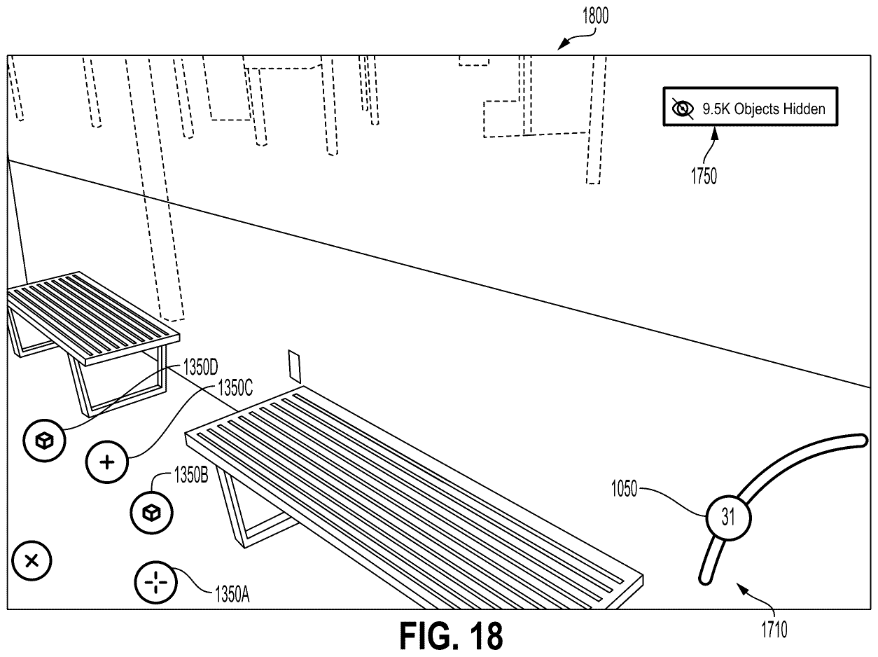

Moving to FIG. 18, an updated GUI view 1800 with respect to the GUI view 1700 of FIG. 17 is depicted in which the user has increased the opacity of the 3D model such that the physical elements can be seen, overlaid on the image data. In particular, because the user has hidden the architectural objects within the 3D model (e.g., furniture, walls, ceilings, etc.), the user can see “through” the wall in front of them to view the structural columns and mechanical objects within the 3D model beyond the room in which the user is standing.

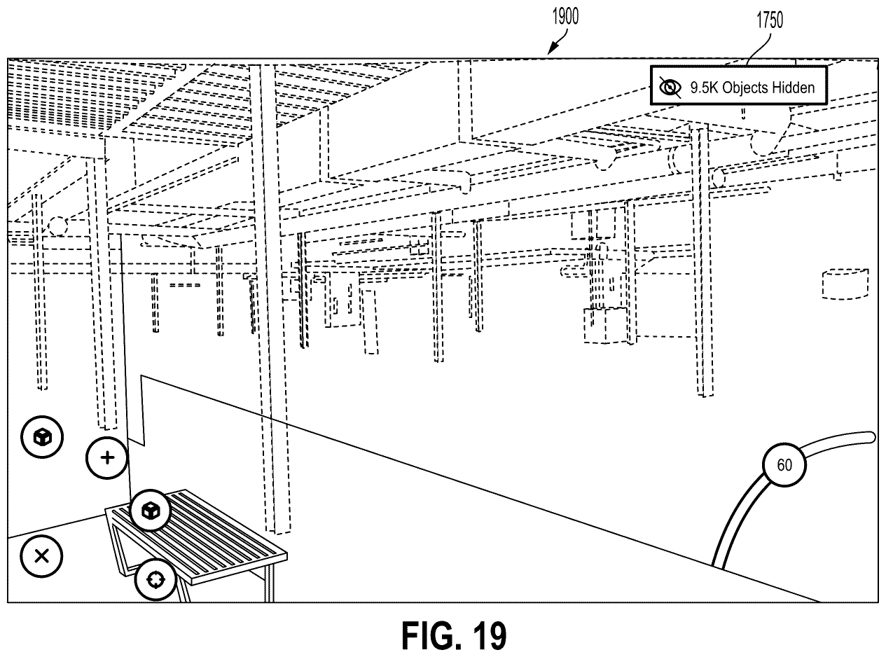

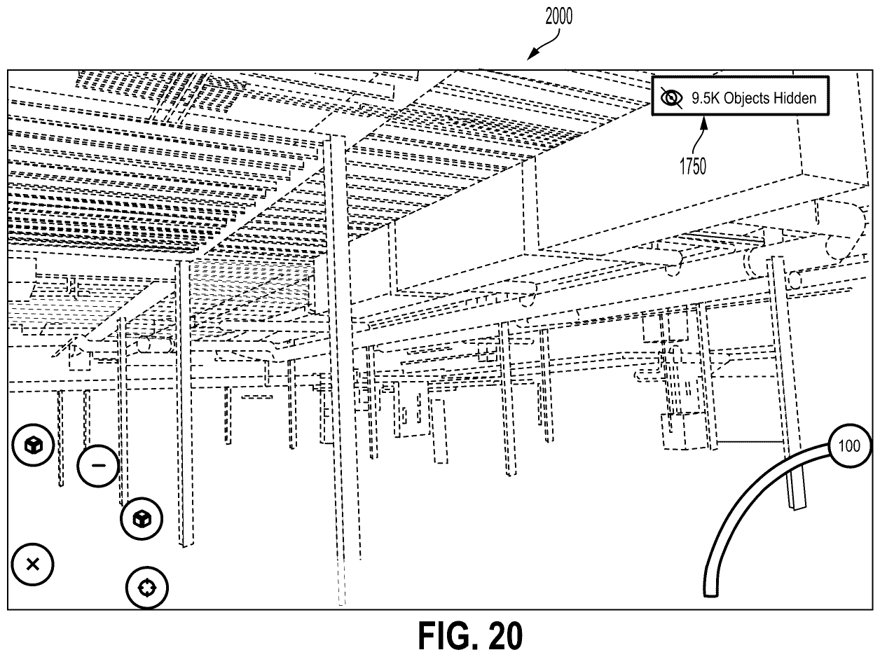

In FIG. 19, a GUI view 1900 is depicted in which the user has adjusted the orientation of the AR-enabled device to point in a more upward direction, revealing the mechanical piping and ductwork objects within the 3D model that would normally be obscured by the ceiling, which is currently hidden along with the other architectural objects. In FIG. 20, a GUI view 2000 is depicted in which the user has further adjusted the upward orientation of the AR-enabled device, revealing more of the structural objects within the 3D model. Further, the user has increased the opacity of the 3D model to 100%, such that image data captured by the one or more cameras of the AR-enabled device is no longer visible.

As will be appreciated from a review of FIGS. 11-20 and the discussion above, once a 3D model is calibrated to the real-world environment, a user has significant flexibility to adjust how the 3D model is displayed in conjunction with aligned image data captured by the AR-enabled device. This may allow a user to isolate specific areas and/or objects within the 3D model, apply one of several different rendering modes, and further control the opacity/transparency of the 3D model with respect to the aligned image data corresponding to the real-world environment, all via a set of conveniently selectable options that are overlaid on the AR view provided by the AR-enabled device.

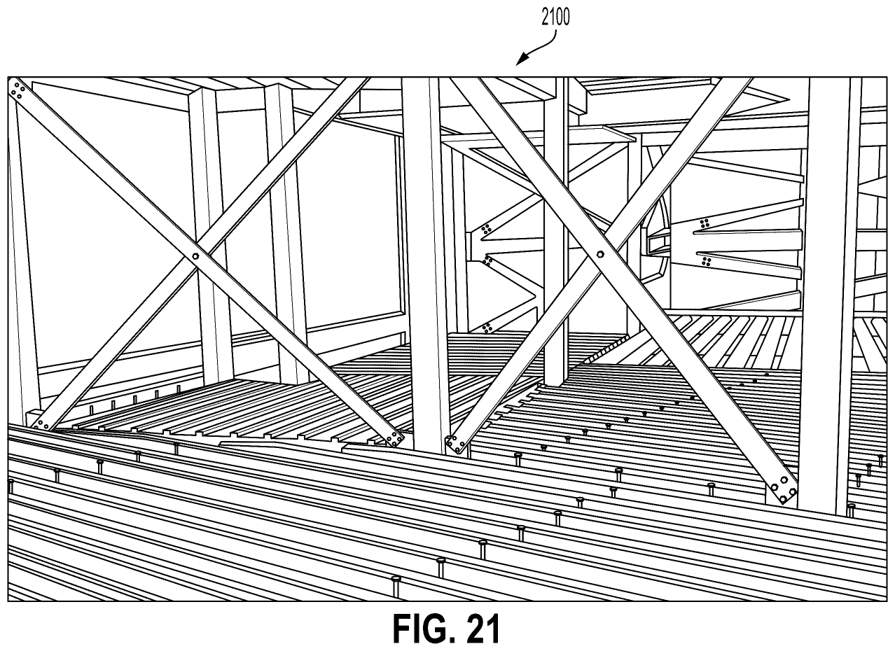

Returning to FIGS. 3-9, another advantage of the new software technology related to z-elevation adjustments of the 3D model will now be discussed. As suggested above, for a given location within a construction project, the surface that the user is standing on at the outset of the calibration process discussed herein may differ depending on the stage of construction. For example, in the early stages of construction when concrete building foundations are being poured, a user located on the ground level of a not-yet-constructed building might be standing on the excavated subgrade—the actual soil—on which the floor slab of the building will eventually be constructed. Similarly, a user on the upper floors of a multi-story building may initially walk along a steel deck, before the concrete floors are poured. An example of this type of site condition can be seen in FIG. 21, which depicts a GUI view 2100 showing image data, as captured by the AR-enabled device, of a construction project in which the steel beams and floor deck have been installed, but the concrete floor slabs have not.

In these situations, a ground floor that is detected by the sensors of the AR-enabled device when the user points the AR-enabled device downward (FIG. 4) will not correspond to the floor that is selected within the 3D model (FIG. 5). Rather, there will be a z-elevation offset between the detected ground surface and the final floor surface that is equal to the thickness of the eventual concrete slab that will be poured. For this reason, the additional Up/Down alignment control element 632 depicted in FIGS. 6-9 may provide for predetermined, incremental adjustments to the z-elevation of the 3D model during the alignment stage discussed above. For example, each tap of the Up or Down buttons may adjust the z-elevation of the 3D model up or down by one half-inch. Accordingly, if the user is standing on the excavated sub-grade and the concrete floor slab will be 4-inches thick, the user may tap the Up button eight times, thereby adjusting the vertical alignment of the model upward by exactly 4 inches.

In some implementations, the Up/Down buttons of the alignment control element 632 may include a visual indication of the increment by which each tap will adjust the vertical alignment of the 3D model. Further, an additional selectable option may be provided that allows the user to adjust the incremental value. For example, the user might toggle between an adjustment value of one half-inch, one inch, or two inches, which may be convenient in situations where the offset between the detected ground surface and the constructed floor surface is large (e.g., a 12-inch thick concrete slab). Still further, the disclosed software technology may include additional functionality that may prompt the user, via a displayed indication on the AR-enabled device during the alignment stage discussed above. For example, after the user selects the floor of the model (FIG. 5), the AR-enabled device may display an overlaid message or similar notification that indicates the thickness of the concrete floor that the user just selected in the 3D model. In this way, if the user is not actually standing on the constructed floor when calibrating the 3D model to the real-world environment, but rather a different surface that precedes the floor during construction, the user will know the elevation offset that needs to be accounted for using the Up/Down buttons during the alignment stage.

As a result, the AR calibration approach provided by the disclosed software technology may be implemented during earlier stages of construction in which there are relatively fewer constructed objects present in the real-world environment, which as noted above is a pre-requisite of some other types of AR calibration approaches.

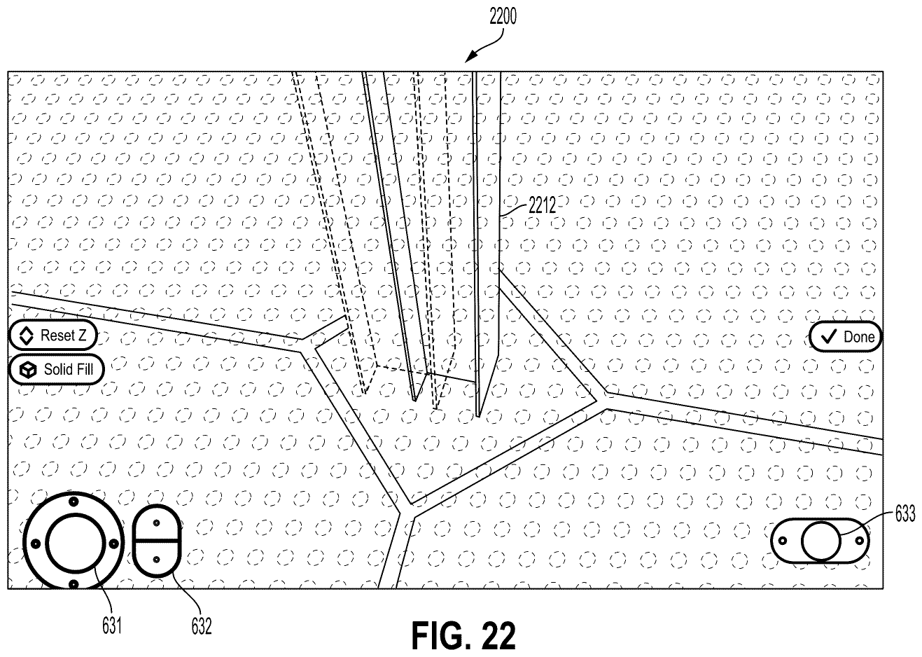

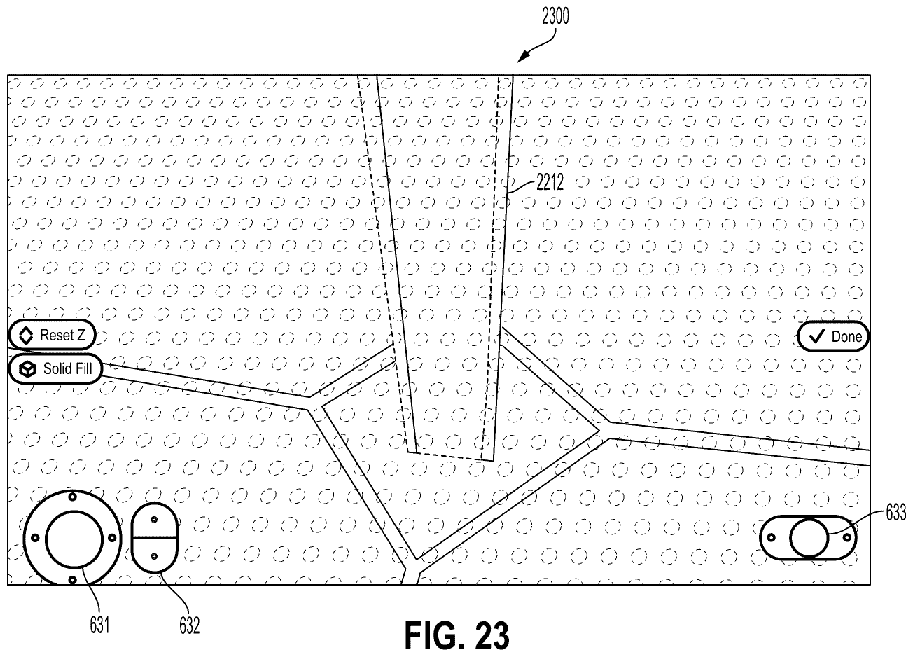

Another illustration of this can be seen in FIG. 22 and FIG. 23, which depict respective GUI views 2200, 2300 that may be presented by the AR-enabled device during the alignment stage discussed above. In FIG. 22, the user has already completed the vertical calibration of the 3D model with the real-world environment by detecting the concrete floor via the AR-enabled device and then selecting the corresponding floor within the 3D model.

Now, the user is aligning the 3D model 220 with the real-world environment based on a single constructed reference object, a steel I-beam 2212, within the real-world environment. For example, FIG. 22 depicts the GUI view 2200 in which the user is calibrating the x-axis of the 3D model with the real-world environment. Further, FIG. 23, depicts the GUI view 2300 in which the user has repositioned the AR-enabled device to view the adjacent side of the I-beam 2212, and is calibrating the y-axis of the 3D model with the real-world environment. Accordingly, unlike other AR calibration approaches that require multiple constructed wall surfaces to be present in the real-world environment, the software technology discussed herein allows for AR calibration under a wider range of site conditions, including much earlier during the construction process.

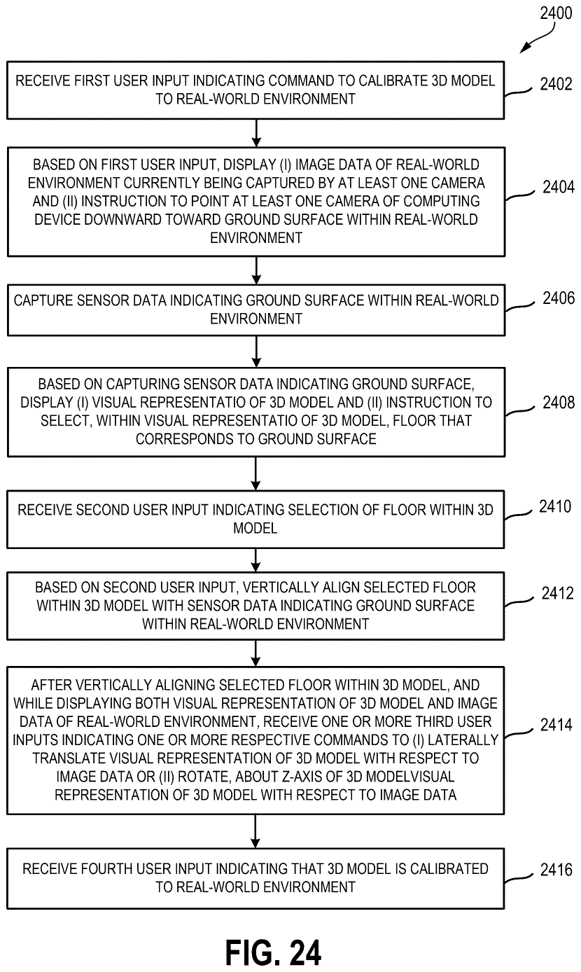

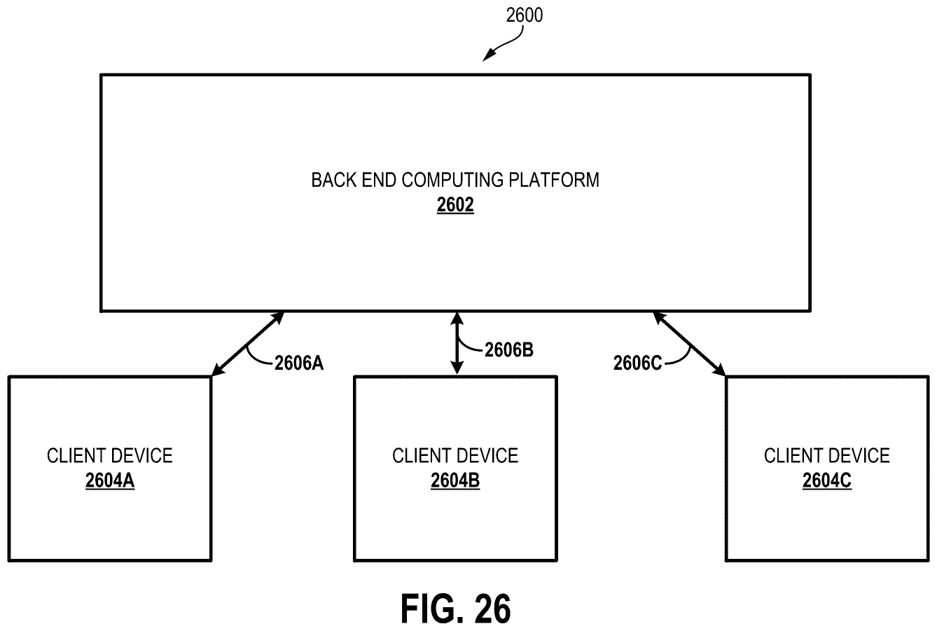

Turning to FIG. 24, example functionality is illustrated in the form of a flow diagram 2400. For purposes of illustration, the example functionality of FIG. 24 is described as being carried out by a client device (e.g., a client device as shown in FIGS. 26 and/or 28 and described below) that is running a construction management software application, but it should be understood that the example functionality of FIG. 24 may be carried out by any client device, computing platform, or combination thereof that is capable of running the software disclosed herein. Further, it should be understood that the example functionality of FIG. 24 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

As shown in FIG. 24, the example flowchart 2400 may begin at block 2402 as a client device receives a first user input indicating a command to calibrate a 3D model to a real-world environment. As noted above, the client device may be an AR-enabled device such as a smartphone, tablet, or the like, that is capable of capturing sensor data (e.g., image data, point cloud data, motion data, etc.) in a real-world environment and is also installed with BIM-viewer software for viewing a 3D model.

At block 2404, based on the first user input, the client device may display image data of the real-world environment currently being captured by at least one camera of the client device. Further, the client device may display an instruction to point the at least one camera of the client device downward toward a ground surface within the real-world environment, one example of which is shown in FIG. 3.

At block 2406, the client device may capture sensor data indicating the ground surface within the real-world environment. As noted above, the captured sensor data may include image data, point cloud data, and the like, or combinations thereof.

At block 2408, based on capturing the sensor data indicating the ground surface, the client device may display a visual representation of the 3D model. As previously discussed with respect to FIG. 4, after detecting the ground surface and establishing a z-elevation for the client device, the client device may automatically transition to displaying the visual representation of the 3D model. Other implementations are also possible, such as an implementation in which a user may provide one or more inputs to confirm the ground surface and transition to the 3D model view. In addition to displaying the visual representation of the 3D model, the client device may display an instruction to select, within the visual representation of the 3D model, a floor that corresponds to the ground surface. One possible example of such an instruction is shown in FIG. 5.

At block 2410, the client device may receive a second user input indicating a selection of a floor within the 3D model. Then at block 2412, based on the second user input, the client device may vertically align the selected floor within the 3D model with the sensor data indicating the ground surface within the real-world environment.

At block 2414, after vertically aligning the selected floor within the 3D model, and while displaying both the visual representation of the 3D model and image data of the real-world environment currently being captured by the at least one camera, the client device may receive one or more third user inputs indicating one or more respective commands to align the visual representation of the 3D model with the displayed image data. The commands may include, for example, laterally translating the visual representation of the 3D model with respect to the image data and/or rotating, about a z-axis of the 3D model, the visual representation of the 3D model with respect to the image data.

At block 2416, the client device may receive a fourth user input indicating that the 3D model is calibrated to the real-world environment. For example, as discussed above, a user might select the “Done” button 655 shown in FIG. 9 to indicate that the visual representation of the 3D model and the captured image data are aligned. In response, the client device may lock the position and orientation of the virtual camera within the 3D model to the position and orientation of the client device's at least one camera in the real-world environment. Accordingly, any translational or rotational movements of the client device (and thus the at least one camera) in the real world environment may be detected by one or more motion sensors of the client device and translated into corresponding movements of the virtual camera, thereby adjusting the visual representation of the 3D model in a corresponding way.

Additional embodiments of the disclosed software technology may enable AR calibration approaches that require the identification of relatively fewer objects in the real-world environment, and the corresponding selection of relatively fewer objects within the visual representation of the 3D model.

One such approach to AR calibration that is contemplated herein may achieve an alignment between a 3D model and a real-world environment based on the identification and selection of a single common point in both the model space coordinate frame of the 3D model and the real space coordinate frame of the real-world environment.

For instance, an AR-enabled device running the software technology discussed herein may initiate a “single-point calibration” process (e.g., based on a user command) by beginning to capture sensor data (e.g., image data, LiDAR point cloud data, etc.) that corresponds to the real-world environment in which the user is located. As the user directs the sensors of the AR-enabled device toward a given object in the real-world environment (e.g., a steel column, a foundation corner, etc.) the AR-enabled device may process the sensor data using one or more image processing techniques, point cloud data processing techniques, sensor fusion techniques, and the like to identify surface features of the given object. For example, based on the captured sensor data, the AR-enabled device may determine two or more edges or other features of the object that intersect with each other and resolve to a single point. In this regard, the point may correspond to a corner or other similarly-defined feature of the given object.

Once a single point is identified, the AR-enabled device may display an indication of the identified point to the user. In some implementations, the AR-enabled device may confirm the point automatically. Alternatively, a selectable option may be displayed for the user to confirm the identified point. Once the point is confirmed, the AR-enabled device may determine a first vector in the real space coordinate frame. The first vector extends along a first direction vector and for a first distance between the selected point and the position of the camera in the real-world environment.

The AR-enabled device may then present a visual representation of the 3D model, with an instruction to select the same corresponding point within the 3D model. In this regard, the BIM viewer software that renders the visual representation of the 3D model may provide one or more object selection tools that may assist the user with selecting the point in a way that is snapped to the corner or other feature of the given object that was selected in real space. Once the point is selected within 3D model, the AR-enabled device may determine a second vector in the model space coordinate frame. The second vector extends along a second direction vector and for a second distance between the selected point and the position of the virtual camera in the 3D model.

Because the two vectors are expressed in different coordinate frames, but share a common selection point that is in the same location in both coordinate frames, the AR-enabled device may determine the translational and rotational difference between the position of the AR-enabled device's camera in real space and the virtual camera in model space. Using this information, the AR-enabled device can translate and rotate the visual representation of the 3D model accordingly, such that the position and orientation of the two cameras are aligned, thereby calibrating the 3D model to the real-world environment.

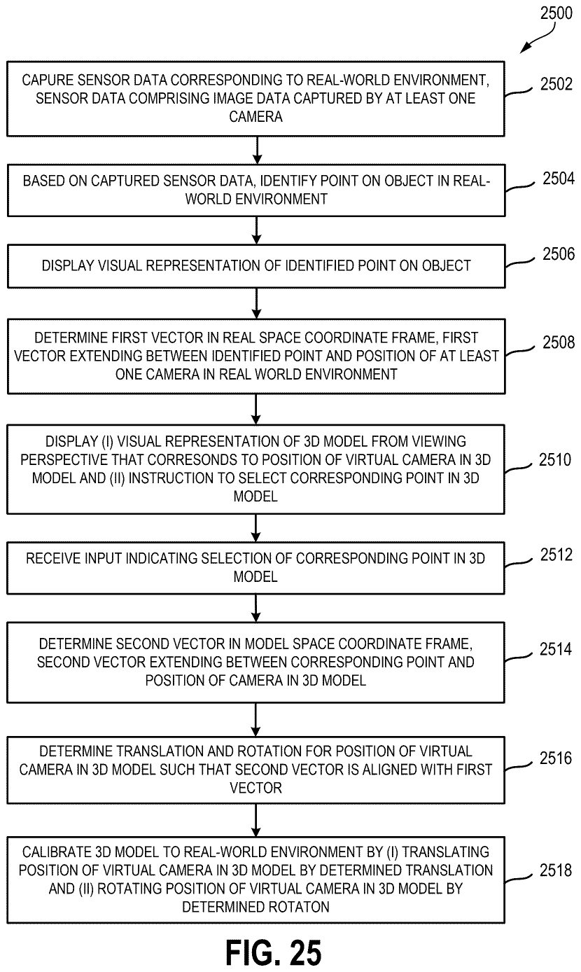

Turning to FIG. 25, example functionality corresponding to the “single-point” calibration discussed above is illustrated in the form of a flow diagram 2500. For purposes of illustration, the example functionality of FIG. 25 is described as being carried out by a client device (e.g., a client device as shown in FIGS. 26 and/or 28 and described below) that is running a construction management software application, but it should be understood that the example functionality of FIG. 25 may be carried out by any client device, computing platform, or combination thereof that is capable of running the software disclosed herein. As with FIG. 24, it should be understood that the example functionality of FIG. 25 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

As shown in FIG. 25, the example flowchart 2500 may begin at block 2502 as a client device captures sensor data corresponding to a real-world environment. In this regard, the sensor data may include image data captured via at least one camera of the client device, point cloud data captured via a LiDAR unit of the client device, and the like.

At block 2504, based on the captured sensor data, the client device may identify a point on an object in the real-world environment. The client device may identify the point based on the captured sensor data in various ways, as generally discussed above. At block 2506, the client device may display a visual representation of the identified point on the object. For example, the identified point may correspond to a corner of a room where two walls and a floor meet. Accordingly, the corner may be highlighted or otherwise indicated in the visual representation of the 3D model. Other examples are also possible. In some implementations, the client device may identify multiple candidate points that are within range of the captured sensor data and may display a visual representation of each of the multiple candidate points for selection by a user of the client device as the identified point to be used for calibration.

At block 2508, the client device may determine a first vector in a real space coordinate frame that extends between the identified point and a position of the at least one camera in the real world environment. In this way, the first vector encodes the positional relationship between the at least one camera and the identified point in the real-world environment.

At block 2510, the client device may display a visual representation of a 3D model from a viewing perspective that corresponds to a position of a virtual camera in the 3D model. Similar to the examples discussed above, the client device may automatically transition to displaying the visual representation of the 3D model after the identified point in the real-world environment is established. Further, the client device may display an instruction to select a point in the 3D model that corresponds to the identified point in the real-world environment. For instance, if the identified point in the real-world environment is the room corner point discussed above, the client device may display an instruction to select a corresponding point in the 3D model, which may include meshes corresponding to the walls and floors of the room. Thus, the user may navigate within the 3D model (using navigation controls as generally discussed above) until the corresponding point is within the displayed view.

At block 2512, the client device may receive an input indicating a selection of the corresponding point in the 3D model. In some examples, the client device may display candidate points for selection by determining the locations of corners, edges, and other snappable points on the meshes of the 3D model as the user navigates within the visual representation of a 3D model.

At block 2514, after receiving the input indicating the selection of the corresponding point in the 3D model, the client device may determine a second vector in a model space coordinate frame that extends between the corresponding point and a position of the virtual camera in the 3D model. In this way, the second vector encodes the positional relationship between the position of the virtual camera and the corresponding point in the 3D model.

At block 2516, the client device may determine one or both of a translation and a rotation for the viewing perspective of the 3D model such that the second vector is aligned with the first vector.

At block 2518, the client device may calibrate the 3D model to the real-world environment by translating the viewing perspective of the 3D model by the determined translation and/or rotating the viewing perspective of the 3D model by the determined rotation. In this way, the virtual representation of the 3D model is adjusted such that the position and orientation of the virtual camera are aligned with the position and orientation of the at least one camera of the client device. Thereafter, the client device may lock the position and orientation of the virtual camera within the 3D model to the position and orientation of the client device's at least one camera in the real-world environment. As discussed above, any translational or rotational movements of the client device (and thus the at least one camera) in the real world environment may be detected by one or more motion sensors of the client device and translated into corresponding movements of the virtual camera, thereby adjusting the visual representation of the 3D model in a corresponding way.

The new software technology discussed herein may be implemented in various ways. In one possible implementation, the disclosed software technology may be running on an AR-enabled device that may be accessible to various users associated with a construction project (e.g., construction professionals). As another possible implementation, the software technology may be distributed between an AR-enabled device and a back-end computing platform (sometimes referred to as a “cloud” platform) in communication with the AR-enabled device that can interact with and/or drive the software technology running on the AR-enabled device. In this regard, the AR-enabled device may take the form of a client device running front end software of a construction management software application that also includes back-end software running on the back-end computing platform. One of ordinary skill in the art will appreciate that the software technology may be running on other computing devices as well, such as other client stations in communication with the AR-enabled device and/or the back-end platform.

In this regard, construction management today is often performed through the use of software applications, such as the software application for construction management provided by Procore Technologies, Inc. ®, the applicant of the present disclosure. These construction management software applications generally provide users with the ability to create, store, view, and/or interact with various types of digital data related to a construction project. In practice, these construction management software applications may take various forms.

As one possible implementation, a construction management software application may include both front-end software (e.g., a web application, desktop application, or mobile application) running on client devices that are accessible to individuals associated with construction projects (e.g., contractors, project managers, architects, engineers, designers, etc.) and back-end software running on a back-end computing platform (sometimes referred to as a “cloud” platform) that interacts with and/or drives the front-end software, and which may be operated (either directly or indirectly) by the provider of the front-end software. This form of a software application may be referred to as a client-server application or a software-as-a-service (SaaS) application, among other possibilities. As another possible implementation, a construction management software application may include front-end software that runs on client devices without interaction with a back-end computing platform. These construction management software applications may take other forms as well.

Turning now to FIG. 26, an example network environment 2600 is depicted in which the disclosed AR calibration software and/or a construction management software application may be implemented. As shown in FIG. 26, the network environment 2600 includes a back-end computing platform 2602 that may be communicatively coupled to one or more client devices 2604, which as shown includes the client device 2604A, the client device 2604B, and the client device 2604C. Although the client devices 2604 are depicted by three devices as shown for the sake of simplicity in illustration, it should be understood that the client devices 2604 may represent more or less than three devices without departing from the spirit and scope of this disclosure.

Broadly speaking, the back-end computing platform 2602 may comprise one or more computing systems that have been provisioned with back-end software for a construction management software application, which may include program code for carrying out one or more of the platform-side functions disclosed herein. The one or more computing systems of the back-end computing platform 2602 may collectively comprise some set of physical computing resources (e.g., one or more processors, data storage system, communication interfaces, etc.), which may take various forms and be arranged in various manners.

For instance, as one possibility, the back-end computing platform 2602 may comprise computing infrastructure of a public, private, and/or hybrid cloud (e.g., computing and/or storage clusters) that has been provisioned with back-end software for the construction management software application. In this respect, the entity that owns and operates the back-end computing platform 2602 may supply its own cloud infrastructure or obtain the cloud infrastructure from a third-party provider of “on demand” computing resources, such as Amazon Web Services (AWS) or the like. As another possibility, the back-end computing platform 2602 may comprise one or more dedicated servers that have been provisioned with back-end software for the construction management software application.

Further, in practice, the back-end software installed at the back-end computing platform 2602 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 26, the back-end software installed at the back-end computing platform 2602 may interact with a data storage layer of the back-end computing platform 2602, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities.

The back-end computing platform 2602 may comprise various other components and take various other forms as well.

In turn, the client devices 2604 may each be any computing device that is capable of running front-end software of the construction management software application, which may include program code for carrying out the client-side functions disclosed herein. In this respect, the client devices 2604 may each include hardware components such as one or more processors, computer-readable mediums, communication interfaces, and input/output (I/O) components (or interfaces for connecting thereto), among others, as well as software components that facilitate the client device's ability to run the front-end software (e.g., operating system software, web browser software, etc.). As representative examples, the client devices 104 may each take the form of a desktop computer, a spatial computer, a laptop, a netbook, a tablet, a smartphone, and/or a personal digital assistant (PDA), among other possibilities.

As further depicted in FIG. 26, the back-end computing platform 2602 is configured to interact with the client devices 2604 over respective communication paths 2606, of which communication paths 2606A, 2606B, and 2606C are shown as examples. In this respect, each respective communication path 2606 between the back-end computing platform 2602 and one of the client devices 2604 may generally comprise one or more communication networks and/or communications links, which may take any of various forms. For instance, each respective communication path 2606 with the back-end computing platform 2602 may include any one or more of Personal Area Networks (PANs), Local-Area Networks (LANs), Wide-Area Networks (WANs) such as the Internet or cellular networks, cloud networks, and/or point-to-point links, among other possibilities. Further, the communication networks and/or links that make up each respective communication path 2606 with the back-end computing platform 2602 may be wireless, wired, or some combination thereof, and may carry data according to any of various different communication protocols. Further yet, communications over each respective communication path 2606 could be carried out via an Application Programming Interface (API), among other possibilities. Still further, although not shown, the respective communication paths 2606 between the client devices 2604 and the back-end computing platform 2602 may also include one or more intermediate systems. For example, it is possible that the back-end computing platform 2602 may communicate with a given client device 2604 via one or more intermediary systems, such as a host server (not shown). The respective communication paths 2606 between the back-end computing platform 2602 and the client devices 2604 may take other forms as well.

Although not shown in FIG. 26, the back-end computing platform 2602 may also be configured to receive data, such as data related to a construction project, from one or more external data sources, such as an external database and/or another back-end computing platform or platforms. Such data sources—and the data output by such data sources—may take various forms.

It should be understood that the network environment 2600 depicted in FIG. 26 is one example of a network environment in which a construction management software application may be implemented. Numerous other arrangements are possible and contemplated herein. For instance, other network configurations may include additional components not pictured and/or more or fewer of the pictured components.

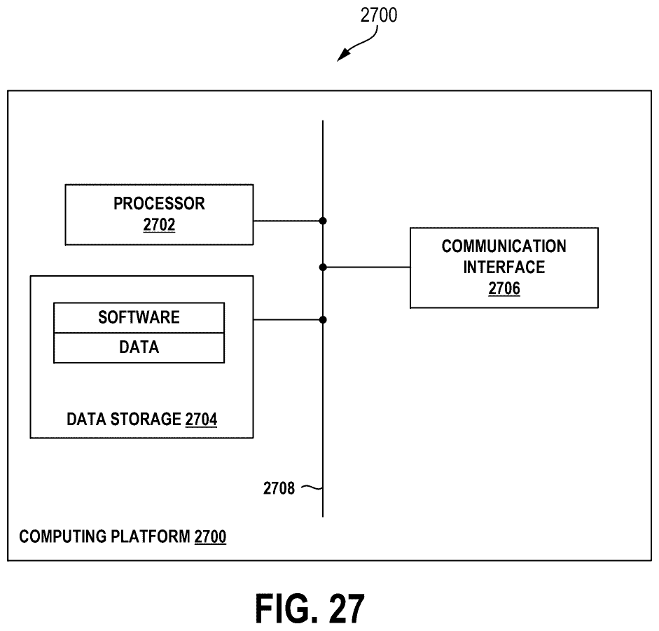

Turning now to FIG. 27, a simplified block diagram is provided to illustrate some structural components that may be included in an example computing platform 2700 that may be configured to perform the platform-side functions disclosed herein. At a high level, the example computing platform 2700 may generally comprise any one or more computer systems (e.g., one or more servers) that collectively include one or more processors 2702, data storage 2704, and one or more communication interfaces 2706, each of which may be communicatively linked by a communication link 2708 that may take the form of a system bus, a communication network such as a public, private, or hybrid cloud, or some other connection mechanism. Each of these components may take various forms.

For instance, the one or more processors 2702 may comprise one or more processor components, such as one or more central processing units (CPUs), graphics processing units (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 2702 could comprise processing components that are distributed across a plurality of physical computing devices connected via a network, such as a computing cluster of a public, private, or hybrid cloud.

In turn, the data storage 2704 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 804 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 27, the data storage 2704 may be capable of storing both (i) program instructions that are executable by the one or more processors 2702 such that the example computing platform 2700 is configured to perform any of the various functions disclosed herein (including but not limited to any of the server-side functions discussed above), and (ii) data that may be received, derived, or otherwise stored by the example computing platform 2700.

The one or more communication interfaces 2706 may comprise one or more interfaces that facilitate communication between the example computing platform 2700 and other systems or devices, where each such interface may be wired and/or wireless and may communicate according to any of various communication protocols. As examples, the one or more communication interfaces 2706 may take include an Ethernet interface, a serial bus interface (e.g., Firewire, USB (Universal Serial Bus) 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

It should be understood that the example computing platform 800 is one example of a computing platform that may be used with the examples described herein. Numerous other arrangements are possible and contemplated herein. For instance, in other examples, the example computing platform 2700 may include additional components not pictured and/or more or less of the pictured components.

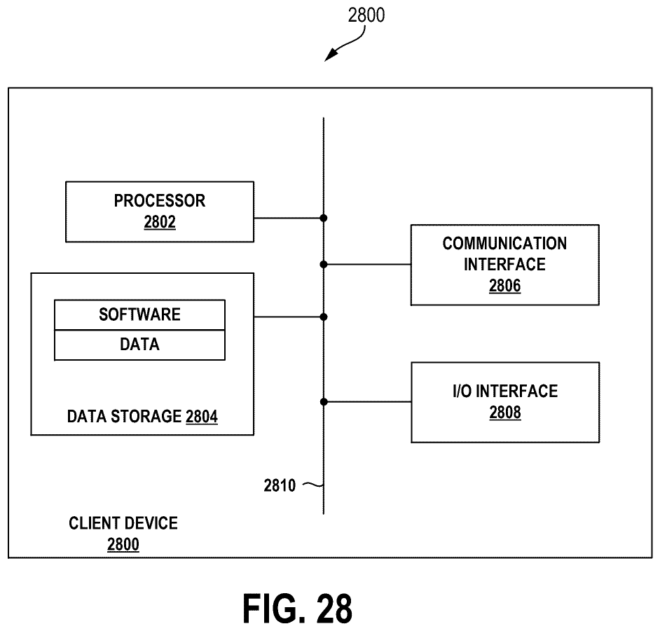

Turning next to FIG. 28, a simplified block diagram is provided to illustrate some structural components that may be included in an example client device 2800 that may be configured to perform some of the client-side functions disclosed herein. At a high level, the example client device 2800 may include one or more processors 2802, data storage 2804, one or more communication interfaces 2806, and an I/O interface 2808, each of which may be communicatively linked by a communication link 2810 that may take the form a system bus and/or some other connection mechanism. Each of these components may take various forms.

For instance, the one or more processors 2802 of the example client device 2800 may comprise one or more processor components, such as one or more CPUs, GPUs, ASICs, DSPs, and/or programmable logic devices such as FPGAs, among other possible types of processing components.

In turn, the data storage 2804 of the example client device 2800 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 28, the data storage 2804 may be capable of storing both (i) program instructions that are executable by the one or more processors 2802 of the example client device 2800 such that the example client device 2800 is configured to perform any of the various functions disclosed herein (including but not limited to any of the client-side functions discussed above), and (ii) data that may be received, derived, or otherwise stored by the example client device 2800.

The one or more communication interfaces 2806 may comprise one or more interfaces that facilitate communication between the example client device 2800 and other systems or devices, where each such interface may be wired and/or wireless and may communicate according to any of various communication protocols. As examples, the one or more communication interfaces 2806 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 2808 may generally take the form of (i) one or more input interfaces that are configured to receive and/or capture information at the example client device 2800 and (ii) one or more output interfaces that are configured to output information from the example client device 2800 (e.g., for presentation to a given user). In this respect, the one or more input interfaces of I/O interface may include or provide connectivity to input components such as a microphone, a camera, a LiDAR unit, a keyboard, a mouse, a trackpad, a touchscreen, an accelerometer, a gyroscope, an inertial measurement unit (IMU), a location signal receiver (e.g., a cellular signal receiver, a Wi-Fi Positioning System (WPS) receiver, a Bluetooth receiver, a Radio Frequency Identification (RFID) receiver, an Ultra-Wideband (UWB) receiver, a magnetic field receiver, a satellite signal receiver such as a GPS, etc.), and/or a stylus, among other possibilities, and the one or more output interfaces of the I/O interface 908 may include or provide connectivity to output components such as a display screen and/or an audio speaker, among other possibilities.

It should be understood that the example client device 2800 is one example of a client device that may be used with the examples described herein, such as the examples above discussing an AR-enabled device. Numerous other arrangements are possible and contemplated herein. For instance, in other examples, the example client device 2800 may include additional components not pictured and/or more or fewer of the pictured components.

### Conclusion

Example embodiments of the disclosed innovations have been described above. Those skilled in the art will understand, however, that changes and modifications may be made to the embodiments described without departing from the true scope and sprit of the present invention, which will be defined by the claims.

For instance, those in the art will understand that the disclosed software technology may facilitate user interaction with a virtual 3D model of a real-world environment that may not necessarily be associated with a construction project.

Further, to the extent that examples described herein involve operations performed or initiated by actors, such as “humans,” “operators,” “users” or other entities, this is for purposes of example and explanation only. The claims should not be construed as requiring action by such actors unless explicitly recited in the claim language.

What is claimed is:

1. A computing device comprising:
at least one camera;
at least one processor;
at least one non-transitory computer-readable medium; and
program instructions stored on the at least one non-transitory computer-readable medium that, when executed by the at least one processor, cause the computing device to:
receive a first user input indicating a command to calibrate a 3D model to a real-world environment;
based on the first user input, display (i) image data of the real-world environment currently being captured by the at least one camera and (ii) an instruction to point the at least one camera of the computing device downward toward a ground surface within the real-world environment;
capture sensor data indicating the ground surface within the real-world environment;
based on capturing the sensor data indicating the ground surface, display (i) a visual representation of the 3D model and (ii) an instruction to select, within the visual representation of the 3D model, a floor that corresponds to the ground surface;
receive a second user input indicating a selection of a floor within the 3D model;
based on the second user input, vertically align the selected floor within the 3D model with the sensor data indicating the ground surface within the real-world environment;
after vertically aligning the selected floor within the 3D model, and while displaying both the visual representation of the 3D model and image data of the real-world environment currently being captured by the at least one camera, receive one or more third user inputs indicating one or more respective commands to (i) laterally translate the visual representation of the 3D model with respect to the image data or (ii) rotate, about a z-axis of the 3D model, the visual representation of the 3D model with respect to the image data; and
receive a fourth user input indicating that the 3D model is calibrated to the real-world environment.

2. The computing device of claim 1, further comprising program instructions stored on the at least one non-transitory computer-readable medium that, when executed by the at least one processor, cause the computing device to:
based on the first user input, automatically transition from displaying the visual representation of the 3D model to displaying image data of the real-world environment currently being captured by the at least one camera, wherein the instruction is overlaid on the image data.

3. The computing device of claim 1, further comprising program instructions stored on the at least one non-transitory computer-readable medium that, when executed by the at least one processor, cause the computing device to:
based on capturing the sensor data indicating the ground surface, automatically transition from displaying image data of the real-world environment currently being captured by the at least one camera to displaying a visual representation of the 3D model, wherein the instruction is overlaid on the visual representation of the 3D model.

4. The computing device of claim 1, further comprising program instructions stored on the at least one non-transitory computer-readable medium that, when executed by the at least one processor, cause the computing device to:
based on based on detecting the second user input, automatically transition from displaying the visual representation of the 3D model to displaying both a visual representation of the 3D model and image data of the real-world environment currently being captured by the at least one camera.

5. The computing device of claim 1, wherein the sensor data comprises point cloud data captured by a LiDAR unit of the computing device.

6. The computing device of claim 1, further comprising program instructions stored on the at least one non-transitory computer-readable medium that, when executed by the at least one processor, cause the computing device to:
display a selectable indication that, when selected, causes the vertical alignment of the 3D model with respect to the real-world environment to be adjusted by a predetermined distance.

7. The computing device of claim 1, further comprising program instructions stored on the at least one non-transitory computer-readable medium that, when executed by the at least one processor, cause the computing device to:
after receiving the fourth user input and while displaying both the visual representation of the 3D model and image data of the real-world environment currently being captured by the at least one camera:
display a selectable indication that, when selected, adjusts an opacity of the visual representation of the 3D model; and
based on receiving an input indicating a user selection of the selectable indication, increase or decrease the opacity of the visual representation of the 3D model.

8. The computing device of claim 1, further comprising program instructions stored on the at least one non-transitory computer-readable medium that, when executed by the at least one processor, cause the computing device to:
after receiving the fourth user input and while displaying both the visual representation of the 3D model and image data of the real-world environment currently being captured by the at least one camera:
display a selectable indication that, when selected, hides one or more classes of objects within the 3D model; and
based on receiving an input indicating user selection of the selectable indication, remove the one or more classes of objects from the visual representation of the 3D model.

9. At least one non-transitory computer-readable medium, wherein the at least one non-transitory computer-readable medium is provisioned with program instructions that, when executed by at least one processor, cause a computing device to:
receive a first user input indicating a command to calibrate a 3D model to a real-world environment;
based on the first user input, display (i) image data of the real-world environment currently being captured by at least one camera and (ii) an instruction to point the at least one camera of the computing device downward toward a ground surface within the real-world environment;
capture sensor data indicating the ground surface within the real-world environment;
based on capturing the sensor data indicating the ground surface, display (i) a visual representation of the 3D model and (ii) an instruction to select, within the visual representation of the 3D model, a floor that corresponds to the ground surface;
receive a second user input indicating a selection of a floor within the 3D model;
based on the second user input, vertically align the selected floor within the 3D model with the sensor data indicating the ground surface within the real-world environment;
after vertically aligning the selected floor within the 3D model, and while displaying both the visual representation of the 3D model and image data of the real-world environment currently being captured by the at least one camera, receive one or more third user inputs indicating one or more respective commands to (i) laterally translate the visual representation of the 3D model with respect to the image data or (ii) rotate, about a z-axis of the 3D model, the visual representation of the 3D model with respect to the image data; and
receive a fourth user input indicating that the 3D model is calibrated to the real-world environment.

10. The at least one non-transitory computer-readable medium of claim 9, wherein the at least one non-transitory computer-readable medium is also provisioned with program instructions that, when executed by the at least one processor, cause the computing device to:
based on the first user input, automatically transition from displaying the visual representation of the 3D model to displaying image data of the real-world environment currently being captured by the at least one camera, wherein the instruction is overlaid on the image data.

11. The at least one non-transitory computer-readable medium of claim 9, wherein the at least one non-transitory computer-readable medium is also provisioned with program instructions that, when executed by the at least one processor, cause the computing device to:
based on capturing the sensor data indicating the ground surface, automatically transition from displaying image data of the real-world environment currently being captured by the at least one camera to displaying a visual representation of the 3D model, wherein the instruction is overlaid on the visual representation of the 3D model.

12. The at least one non-transitory computer-readable medium of claim 9, wherein the at least one non-transitory computer-readable medium is also provisioned with program instructions that, when executed by the at least one processor, cause the computing device to:
based on based on detecting the second user input, automatically transition from displaying the visual representation of the 3D model to displaying both a visual representation of the 3D model and image data of the real-world environment currently being captured by the at least one camera.

13. The at least one non-transitory computer-readable medium of claim 9, wherein the at least one non-transitory computer-readable medium is also provisioned with program instructions that, when executed by the at least one processor, cause the computing device to:
display a selectable indication that, when selected, causes the vertical alignment of the 3D model with respect to the real-world environment to be adjusted by a predetermined distance.

14. The at least one non-transitory computer-readable medium of claim 9, wherein the at least one non-transitory computer-readable medium is also provisioned with program instructions that, when executed by the at least one processor, cause the computing device to:
after receiving the fourth user input and while displaying both the visual representation of the 3D model and image data of the real-world environment currently being captured by the at least one camera:
display a selectable indication that, when selected, adjusts an opacity of the visual representation of the 3D model; and
based on receiving an input indicating a user selection of the selectable indication, increase or decrease the opacity of the visual representation of the 3D model.

15. The at least one non-transitory computer-readable medium of claim 9, wherein the at least one non-transitory computer-readable medium is also provisioned with program instructions that, when executed by the at least one processor, cause the computing device to:
after receiving the fourth user input and while displaying both the visual representation of the 3D model and image data of the real-world environment currently being captured by the at least one camera:
display a selectable indication that, when selected, hides one or more classes of objects within the 3D model; and
based on receiving an input indicating user selection of the selectable indication, remove the one or more classes of objects from the visual representation of the 3D model.

16. A method carried out by a computing device, the method comprising:
receiving a first user input indicating a command to calibrate a 3D model to a real-world environment;
based on the first user input, displaying (i) image data of the real-world environment currently being captured by at least one camera and (ii) an instruction to point the at least one camera of the computing device downward toward a ground surface within the real-world environment;
capturing sensor data indicating the ground surface within the real-world environment;
based on capturing the sensor data indicating the ground surface, displaying (i) a visual representation of the 3D model and (ii) an instruction to select, within the visual representation of the 3D model, a floor that corresponds to the ground surface;
receiving a second user input indicating a selection of a floor within the 3D model;
based on the second user input, vertically aligning the selected floor within the 3D model with the sensor data indicating the ground surface within the real-world environment;
after vertically aligning the selected floor within the 3D model, and while displaying both the visual representation of the 3D model and image data of the real-world environment currently being captured by the at least one camera, receiving one or more third user inputs indicating one or more respective commands to (i) laterally translate the visual representation of the 3D model with respect to the image data or (ii) rotate, about a z-axis of the 3D model, the visual representation of the 3D model with respect to the image data; and
receiving a fourth user input indicating that the 3D model is calibrated to the real-world environment.

17. The method of claim 16, further comprising:
based on the first user input, automatically transitioning from displaying the visual representation of the 3D model to displaying image data of the real-world environment currently being captured by the at least one camera, wherein the instruction is overlaid on the image data.

18. The method of claim 16, further comprising:
based on capturing the sensor data indicating the ground surface, automatically transitioning from displaying image data of the real-world environment currently being captured by the at least one camera to displaying a visual representation of the 3D model, wherein the instruction is overlaid on the visual representation of the 3D model.

19. The method of claim 16, further comprising:
based on based on detecting the second user input, automatically transitioning from displaying the visual representation of the 3D model to displaying both a visual representation of the 3D model and image data of the real-world environment currently being captured by the at least one camera.

20. The method of claim 16, further comprising:
displaying a selectable indication that, when selected, causes the vertical alignment of the 3D model with respect to the real-world environment to be adjusted by a predetermined distance.
